(19) United States
(12) Patent Application Publication
(10) Pub. No.: US 2026/0352690 A1
(43) Pub. Date: Nov. 5, 2026

(54) DETECTING VULNERABILITIES ASSOCIATED WITH BINARY FUNCTIONS UTILIZING GENERATIVE AGENTS

(71) Applicant: OpenAI OpCo, LLC, San Francisco, CA (US)

(72) Inventors: David Aitel, Miami Beach, FL (US); Akshay Bhat, New York, NY (US); Matthew Knight, San Francisco, CA (US)

(21) Appl. No.: 19/365,017

(22) Filed: Oct. 21, 2025

Related U.S. Application Data
(60) Provisional application No. 63/798,122, filed on May 1, 2025.

(51) Int. Cl. H04L 9/40

(52) U.S. Cl. CPC H04L 63/1433

(57) ABSTRACT

The present disclosure relates to systems, non-transitory computer-readable media, and methods for improving the security analysis of computer code. In particular, the disclosed systems can retrieve a binary function from a binary repository of a computer application. In one or more embodiments, the disclosed systems can perform an initial threat analysis of the binary function by utilizing a reverse-engineering platform to determine a threat ranking for the binary function. In some cases, the disclosed systems can utilize a large language model to generate a threat model in the form of a structured data object that defines threat parameters corresponding to the computer application. Additionally, the disclosed systems can utilize a large language model and threat model to analyze the binary function based on the threat ranking to generate a threat object that indicates threat data associated with the binary function.

### CROSS-REFERENCE TO RELATED APPLICATIONS

This application claims priority to and the benefit of U.S. Provisional Patent Application No. 63/798,122, filed on May 1, 2025, which is incorporated herein by reference in its entirety.

### BACKGROUND

Recent years have seen significant development in applying automated analysis and machine learning to identify vulnerabilities in computer code and computer applications. For example, prior work has combined static analysis, symbolic execution, fuzzing, and large language models (LLMs) to surface memory-safety defects and logic errors. However, many of these conventional approaches remain limited when applied to compiled binaries at production scale, and continue to exhibit important practical disadvantages in security, flexibility, robustness, and computing efficiency.

As indicated above, some existing systems are insecure due to design flaws. For instance, conventional pipelines often perform heavy analysis inside a central control plane or mix sensitive data (or artifacts) with orchestration code, increasing the risk that secrets or proprietary binaries leak or that analysis state contaminates decision logic (including LLM prompts). These risks are amplified when analysis is performed without strong isolation between untrusted inputs and the system components that decide actions or invoke models, leaving systems exposed to prompt injection and data-exfiltration vectors that provide paths for phishing, malware, and/or vulnerability exploits.

On top of security issues, some existing systems are inflexible. For example, many conventional approaches rely on brittle parsers, language-specific tooling, or static analysis rules hand-tuned for particular codebases or languages. This per-language, per-framework tuning prevents tools from operating uniformly across heterogeneous environments (for example, stripped binaries, mixed-architecture repositories, or third-party components) and impedes scalable, platform-agnostic deployment.

On top of security and inflexibility, some conventional systems exhibit poor computational efficiency. For instance, some conventional systems often redundantly re-scan or re-analyze large codebases end-to-end for each run, which results in duplicated work, long runtimes, and wasted CPU and memory resources. Such inefficiency is particularly costly when expensive operations (for example, decompilation, symbolic execution, or frequent LLM calls) are applied indiscriminately rather than focused on a prioritized subset of code.

Existing systems further hinder scalability and robustness. Many tools attempt to perform whole-program analysis in a single process, which leads to resource exhaustion, brittle long-running jobs, and high variability in throughput.

### SUMMARY

This disclosure describes systems, methods, and non-transitory computer-readable media for applying generative artificial intelligence to improve the security analysis of computer code. In particular, the disclosed systems can retrieve a binary function from a binary repository of a computer application. In one or more embodiments, the disclosed systems can perform an initial threat analysis of the binary function by utilizing a reverse-engineering platform to determine a threat ranking for the binary function. In some cases, the disclosed systems can utilize a large language model (or large language model agent) to generate a threat model in the form of a structured data object that defines threat parameters corresponding to the computer application. Additionally, the disclosed systems can utilize a large language model (or large language model agent) and threat model to analyze the binary function based on the threat ranking to generate a threat object that indicates threat data associated with the binary function, thereby providing an intelligent and adaptive mechanism for detecting security issues within binary repositories of computer applications.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIG. 1 illustrates a high-level architecture of a generative artificial intelligence (AI) system in accordance with one or more embodiments.

FIG. 2 illustrates a schematic diagram of an example environment of a binary threat detection system in accordance with one or more embodiments.

FIG. 3 illustrates an example overview of a binary threat detection system generating a threat object in accordance with one or more embodiments.

FIG. 4 illustrates a binary threat detection system enumerating and filtering binary functions in accordance with one or more embodiments.

FIG. 5 illustrates a binary threat detection system generating a call graph in accordance with one or more embodiments.

FIG. 6 illustrates a binary threat detection system generating a threat model utilizing a large language model agent in accordance with one or more embodiments.

FIG. 7 illustrates a binary threat detection system determining a threat ranking for a binary function in accordance with one or more embodiments.

FIG. 8 illustrates a binary threat detection system generating a threat object by analyzing a binary function within an isolated container in accordance with one or more embodiments.

FIG. 9 illustrates a binary threat detection system validating a threat object utilizing a validation agent in accordance with one or more embodiments.

FIG. 10 illustrates an exemplary graphical user interface in accordance with one or more embodiments.

FIG. 11 illustrates an example series of acts performed by a binary threat detection system in accordance with one or more embodiments.

FIG. 12 illustrates a block diagram of an exemplary computing device in accordance with one or more embodiments.

FIG. 13 illustrates an example environment of a networking system having a generative AI system in accordance with one or more embodiments.

### DETAILED DESCRIPTION

This disclosure describes one or more embodiments for a binary threat detection system that employs a control plane implemented in asynchronous orchestration logic to check for vulnerabilities within a computer application by analyzing binary functions associated with the computer application. In particular, the binary threat detection system uses a control plane to direct execution in discrete phases—function enumeration, call graph extraction, function ranking, annotation, vulnerability analysis, and exploit narrative filtering—to detect a bug associated with the binary function and determine if the bug exposes a vulnerability within the computer application. For example, the binary threat detection system can retrieve a binary function from a collection or repository of binary functions associated with a computer application. In some cases, the binary threat detection system can perform an initial threat analysis on the binary function to determine an initial likelihood, severity, and/or risk of a bad actor leveraging the vulnerability and/or bug associated with the binary function. For example, the binary threat detection system can determine a threat ranking for the binary function indicating an initial finding of the risk associated with the vulnerability. In one or more cases, the binary threat detection system can perform additional vulnerability analysis on the binary function. For example, the binary threat detection system can generate a threat model comprising a structured object that defines threat parameters (e.g., attack surfaces, vulnerability classes, threat prioritization criteria) associated with the binary function. In some instances, the binary threat detection system can generate the threat model with a large language model (or large language model agent). Moreover, the binary threat detection system can perform additional vulnerability analysis on the binary function by analyzing the binary function together with the threat model with the large language model (or large language model agent). In some cases, the large language model (or large language model agent) can generate a threat object comprising information outlining the threat data associated with the binary function.

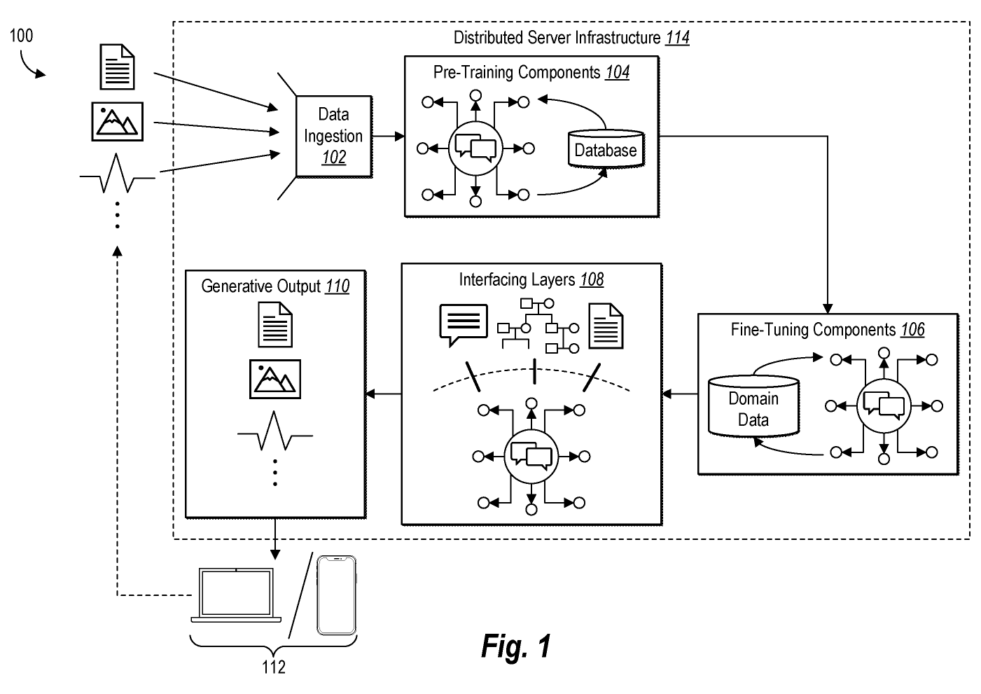

FIG. 1 illustrates a high-level architecture of a generative artificial intelligence (“AI”) system 100 for implementing large language models and other generative models to enable natural language processing, conversational interfaces, multimodal content generation, and analysis in accordance with one or more embodiments. The generative AI system 100 may include data ingestion pipelines 102, pre-training components 104, fine-tuning components 106, interfacing layers 108, and supporting hardware in the form of a distributed server infrastructure 114.

The data ingestion pipelines 102 of the generative AI system 100 may receive and preprocess large volumes of structured and unstructured data, including text corpora, image datasets, video datasets, and audio datasets, to support diverse generative model training. Preprocessing may include deduplication, tokenization, normalization, feature extraction (e.g., spectrogram generation for audio), and content safety filtering, preparing data for effective distributed training across server devices.

The pre-training components 104 of the generative AI system 100 may utilize transformer-based architectures for LLMs, as well as additional generative models such as diffusion models for image generation, autoencoders for representation learning, and multimodal transformer models for cross-domain generation tasks. These models may be configured with deep neural network stacks to capture hierarchical, semantic, and contextual relationships within the data.

The generative AI system 100 may employ diffusion models for image and video generation, where the models learn to iteratively denoise random noise into structured outputs conditioned on textual or other modality inputs. The generative AI system 100 may train these models using score-based or denoising diffusion probabilistic methods across distributed server devices within the distributed server infrastructure 114.

The generative AI system 100 may also implement speech generation models, including text-to-speech (TTS) systems using autoregressive or non-autoregressive architectures, and audio diffusion models capable of generating high-fidelity waveforms conditioned on linguistic and prosodic features. Feature extraction components may preprocess audio data to create Mel-spectrograms or other representations used during model training using the pre-training components 104.

Specialty server devices within the generative AI system 100, such as those of the distributed server infrastructure 114, may include GPUs, TPUs, or custom AI accelerators designed for high-throughput operations supporting both transformer and diffusion model training. These servers may differ from ordinary servers by incorporating high-bandwidth memory (HBM), advanced interconnects (e.g., NVLink, PCIe Gen5), and thermal and power management systems optimized for large-scale generative model workloads.

The generative AI system 100 may store shard-specific checkpoints, intermediate latents, and optimizer states for large-scale diffusion models, LLMs, and multimodal models on high-speed local or network-attached storage within the specialty servers, enabling resumption of training and inference jobs after interruptions or updates.

The fine-tuning components 106 of the generative AI system 100 may adapt generative models to specific user tasks or domain tasks, such as personalized content generation, domain-specific summarization, image style transfer, or voice cloning. Fine-tuning may involve supervised fine-tuning on task-specific datasets and reinforcement learning with human feedback (RLHF), where applicable, with data and gradients distributed across server devices for scalable operation.

The interfacing layers 108 of the generative AI system 100 may handle user prompts for LLM-based text generation, text-to-image generation requests, and speech synthesis requests. The system may tokenize or encode user prompts, generate conditioning latents where applicable (e.g., CLIP embeddings for image generation), and distribute inference tasks across server clusters for each modality-specific generative model. The interfacing layers 108 may include computer scripts, subroutines, or integrated tools for processing prompts, implementing models, and/or performing API calls to supplement and/or augment generative functions of LLMs and other models of the generative AI system 100. In some embodiments, the interfacing layers 108 include databases for accessing stored content (e.g., a vector database of content vectors for comparing with prompt vectors or query vectors) for contextual augmentation of model operation (e.g., for retrieval-augmented generation and its analogs). In some embodiments, the interfacing layers 108 integrate functionality from third-party systems (e.g., external to the generative AI system 100 and/or the distributed server infrastructure 114) into the generative AI system 100 using APIs and/or particular communication protocols to interact with generative model data (e.g., to execute generated code).

As illustrated in FIG. 1, the generative AI system 100 generates generative output 110. The generative AI system 100 can generate the generative output 110 in the form of text responses, images, videos, audio clips, or other multimodal digital content. The generative AI system 100 can generate the generative output 110 using the interfacing layers 108 in conjunction with one or more trained (e.g., pre-trained and fine-tuned, using the described components) generative models, including LLMs and others described herein.

In some embodiments, the generative AI system 100 generates the generative output 110 over one or more conversational interactions or turns with client device(s) 112. Indeed, the generative AI system 100 can provide the generative output 110 for display on the client device(s) 112. In addition, the generative AI system 100 can receive additional input in the form of text-based queries or prompts, images, videos, audio clips, and/or other multimodal content as part of an ongoing conversation between the generative AI system 100 and the client device(s) 112 and/or as part of a new conversation or instantiation of the generative AI system 100.

For large generative models exceeding single-device memory, the generative AI system 100 may implement model parallelism, with different server devices processing partitions of the model during inference across the distributed server infrastructure 114, and may use activation checkpointing and memory recomputation strategies to handle resource constraints efficiently across distributed modalities.

Server devices within the generative AI system 100 may utilize high-bandwidth interconnects for low-latency tensor and latent exchange during multi-stage generation processes (e.g., latent generation followed by decoding in diffusion models). This enables the generative AI system 100 to support complex, multi-step generation tasks, such as generating text and subsequently generating images conditioned on the generated text, while maintaining low latency.

The distributed server infrastructure 114 of the generative AI system 100 may include compute clusters with racks of specialty servers interconnected with high-bandwidth networking technologies such as InfiniBand, RDMA-enabled Ethernet, or custom fabrics, and distributed storage using NVMe over Fabrics (NVMe-oF) for rapid access to large model weights, intermediate outputs, and context data during inference.

The distributed server infrastructure 114 can include safety filtering and content moderation layers that operate in parallel with inference pipelines across modalities, applying token-level filtering for LLM outputs, image or video classification for generated visual content, and audio analysis for speech outputs to ensure outputs comply with operational policies and applicable regulations.

The distributed server infrastructure 114 can include orchestration and resource management layers that dynamically allocate compute, memory, and network resources across modalities, scaling generative model training and inference in response to user demand and system load while monitoring resource health across components of the generative AI system 100.

Collectively, the architecture illustrated in FIG. 1 enables the generative AI system 100 to provide scalable, efficient, and safe generative model services across text, image, video, audio, and other modalities, leveraging specialty server devices and distributed computing for high-throughput training, fine-tuning, and inference across a wide variety of generative AI applications.

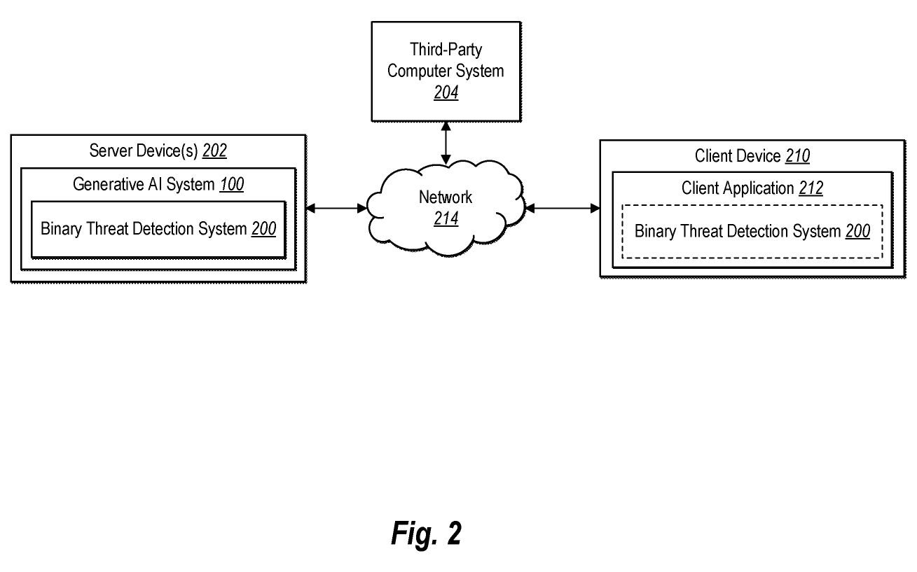

FIG. 2 illustrates a schematic diagram of an example system environment for implementing a binary threat detection system in accordance with one or more implementations. An overview of the binary threat detection system is described in relation to FIG. 2.

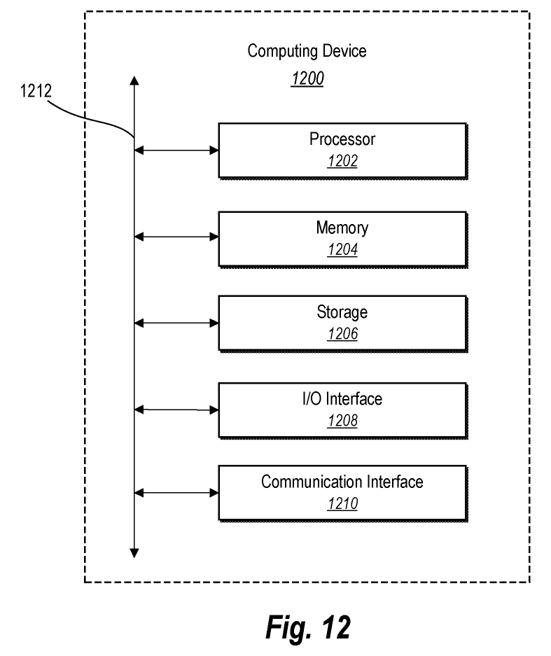

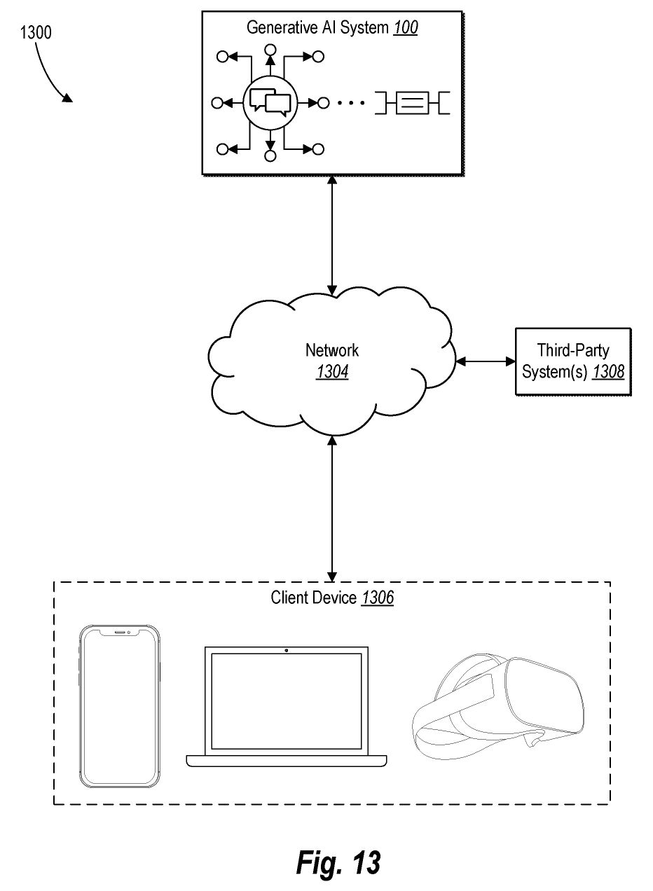

As shown, the environment includes server device(s) 202, a third-party computer system 204, a client device 210, and a network 214. Each of the components of the environment can communicate via the network 214, and the network 214 may be any suitable network over which computing devices can communicate. Example networks are discussed in more detail below in relation to FIGS. 12-13.

As mentioned above, the example environment includes a client device 210. The client device 210 can be one of a variety of computing devices, including a smartphone, a tablet, a smart television, a desktop computer, a laptop computer, a virtual reality device, an augmented reality device, or another computing device as described in relation to FIGS. 12-13. The client device 210 can communicate with the server device(s) 202 via the network 214. For example, the client device 210 can receive user input from a user interacting with the client device 210 (e.g., via the client application 212) to, for instance, interact with a generative AI system 100 located on the server device(s) 202. In addition, the binary threat detection system 200 on the server device(s) 202 can receive information relating to various interactions with user interface elements based on the input received by the client device 210.

As shown, the client device 210 can include a client application 212. In particular, the client application 212 may be a web application, a native application installed on the client device 210 (e.g., a mobile application, a desktop application, etc.), or a cloud-based application where all or part of the functionality is performed by the server device(s) 202. Based on instructions from the client application 212, the client device 210 can present or display information, including a threat object, a validated threat object, a dialogue, or a thread between a client device associated with a user and the large language model.

As illustrated in FIG. 2, the example environment also includes the server device(s) 202. The server device(s) 202 may generate, track, store, process, receive, search, communicatively link, and transmit electronic data, such as digital content (e.g., content items), datasets, messages, searchable data, pages of data, prompts, user queries, interface elements, external tools, binary functions, bounded code segments, artifacts, threat objects, interactions with interface elements, and/or interactions between user accounts or client devices and the generative AI system 100. For example, the server device(s) 202 may receive data from the client device 210 in the form of a user query. Additionally, the device(s) 202 can process inputs through the large language model and return generated outputs such as text, summaries, accessible tools, exploitation narratives, code, threat objects, and/or call graphs. In some embodiments, the device(s) 202 manage auxiliary tasks such as session tracking, context management, content filtering, and integration with databases or external tools. Indeed, the server device(s) 202 can communicate with the client device 210 to send and/or receive data via the network 214. In some implementations, the server device(s) 202 comprise(s) a distributed server where the server device(s) 202 include(s) a number of server devices distributed across the network 214 and located in different physical locations. The server device(s) 202 can comprise one or more content servers, application servers, communication servers, web-hosting servers, machine learning servers, and other types of servers.

As shown in FIG. 2, the server device(s) 202 can also include the binary threat detection system 200 as part of a generative AI system 100. The generative AI system 100 can communicate with the client device 210 to perform various functions associated with the client application 212, such as receiving user queries, scanning a binary repository, enumerating binary functions, generating a call graph, ranking binary functions, performing an initial threat analysis, and/or generating a threat object. In one or more cases, the binary threat detection system 200 can perform tasks on a third-party computer system 204 that is connected to the generative AI system 100. The generative AI system 100 ingests structured or unstructured input data from respective data sources and/or binary repositories and uses the large language model to generate a threat model and intelligently produce outputs, threat objects, and/or recommended actions for addressing vulnerabilities in a computer application (or computer code).

Although FIG. 2 depicts the binary threat detection system 200 located on the server device(s) 202, in some implementations, the binary threat detection system 200 may be implemented by (e.g., located entirely or in part on) one or more other components of the environment. For example, the binary threat detection system 200 may be implemented by the client device 210 and/or a third-party device. For example, the client device 210 can download all or part of the binary threat detection system 200 for implementation independent of, or together with, the server device(s) 202. In some embodiments, the binary threat detection system 200 is implemented as a plug-in or modular extension associated with the large language model.

As shown in FIG. 2, the example environment also includes a third-party computer system 204. In one or more embodiments, the third-party computer system is external to the device(s) 202 and stores data, binary functions, and/or computer code associated with the third-party computer system 204. As shown in FIG. 2, in one or more cases, the third-party computer system 204 can communicate with the server device(s) 202 over the network 214. In one or more embodiments, the third-party computer system 204 can communicate with the generative AI system 100 or the binary threat detection system via a connector connecting the third-party computer system 204 to the generative AI system 100.

In some implementations, though not illustrated in FIG. 2, the environment may have a different arrangement of components and/or may have a different number or set of components altogether. For example, the client device 210 may communicate directly with the binary threat detection system 200, bypassing the network 214. As another example, the environment can include a database located external to the server device(s) 202 (e.g., in communication via the network 214) or located on the server device(s) 202, on third-party servers, and/or on the client device 210.

As illustrated by the foregoing discussion, the present disclosure utilizes a variety of terms to describe features and benefits of the binary threat detection system 200. Additional detail is provided hereafter regarding the meaning of these terms as used in the disclosure. As used herein, the term “binary function” can include or refer to a function that performs an operation utilizing a binary format. For example, a binary function can include binary data or bytes. In some cases, a binary function can be a single, callable unit that executes an action. For example, a binary function can correspond to authentication checks (e.g., accept_auth), read requests (e.g., http_read_request), parsers (e.g., parse_request), memory/allocation sinks (e.g., free_and_use), etc., associated with a computer application. In one or more cases, the binary threat detection system 200 can record, track, and/or save binary functions and/or binary artifacts by storing one or more binary functions in a binary repository. In one or more cases, a binary function may have a unique identifier (e.g., start address), metadata, function boundaries, etc. Relatedly, as used herein, the term “binary repository” can include or refer to a database or store that manages binary functions and/or binary artifacts. For example, a binary repository can include a list of raw binaries, libraries, and/or metadata related to binary functions.

As used herein, the term “reverse-engineering platform” can include or refer to a framework that analyzes and reverse-engineers compiled code (e.g., binary repository). In one or more cases, the reverse-engineering platform (e.g., Ghidra) can include a suite of tools for importing, enumerating, decompiling, disassembling, analyzing, etc., compiled code. For example, in or more cases, the suite of tools can include, but are not limited to, JDK 21, CLI tooling (e.g., radare2, rzin, Capstone, binutils), and/or ToolBerry. Indeed, the binary threat detection system 200 can utilize various tools to detect and analyze vulnerabilities associated with binary functions.

As used herein, the term “threat ranking” can include or refer to a deterministic or probabilistic scoring process that orders or prioritizes binary functions (or program artifacts) according to measured or inferred security risk. In one or more cases, the binary threat detection system 200 can generate the threat ranking as part of a preliminary analysis to identify interesting or relevant binary functions associated with vulnerabilities.

As used herein, the term “threat object” can include or refer to a structured data object generated by a large language model (or a large language model agent) that describes one or more identified security issues associated with a binary function (or other program artifact). In one or more embodiments, a threat object codifies the result of analyzing a binary function together with a threat model and comprises human-readable summaries, machine-actionable evidence references, prioritization metadata, and/or optional validation outputs. A threat object can include an identifier, a short summary of the finding, an exploitation narrative, one or more vulnerability class labels, one or more evidence references that map claims to concrete artifacts (e.g., function addresses, call-paths, decompile refs, or call graph path identifiers), a severity (or priority) tag, recommended actions or mitigations, a validation status, and/or provenance metadata (e.g., generator agent id, model version, input artifact ids, timestamps). The threat object can be a versioned unit utilized for downstream triage. In some cases, the threat object can be generated by an AI model or machine-learning model (or agent).

As used herein, the term “threat model” can include or refer to a model or data structure that defines security-relevant parameters for reference in analyzing binary functions and/or binary artifacts based on the security-relevant parameters (e.g., vulnerability threat and/or taint attributes). For example, in one or more cases, the threat model can include a structured data object that defines threat parameters, such as, attack surfaces (e.g., network listeners, IPC, filer parsers), vulnerability classes (e.g., memory-safety), and/or threat prioritization criteria (e.g., weights) associated with a binary function and/or a binary artifact associated with the binary function. In one or more cases, the threat model can be (generated by) a machine-learning model, a neural network, or a large language model. In one or more embodiments, the threat model can be an algorithm or statistical model. Moreover, in some cases, the threat model can be a heuristic or a rule-based model. Additionally, the threat model can provide context about the vulnerabilities of the computer code. In one or more cases, the 200 can utilize (or propagate) the threat model at each of the vulnerability analysis stages (e.g., enumeration, annotation, filtering, etc.) to guide the analysis of binary functions.

As used herein, the term “large language model” (or “LLM”) refers to a computational model configured to process and generate human-readable text by learning statistical and contextual relationships within natural language data using machine learning techniques. An LLM typically comprises a deep neural network architecture, such as a transformer-based architecture with multiple layers and attention mechanisms, and is trained on large corpora of text using objectives such as masked language modeling, causal language modeling, or autoregressive prediction. The LLM may include billions or trillions of parameters and is capable of performing a variety of language tasks, including but not limited to text generation, summarization, translation, and question answering, by generating outputs based on input prompts in a contextually relevant manner.

Relatedly, the term “machine learning model” refers to a computational construct comprising one or more algorithms and associated parameters that are configured to perform tasks by identifying patterns or relationships within data. A machine learning model may be trained using supervised, unsupervised, semi-supervised, or reinforcement learning techniques, where the model parameters are adjusted based on input data to minimize a loss function or maximize a reward signal. The machine learning model may include, but is not limited to, neural networks (e.g., convolutional neural networks, recurrent neural networks, transformer models), decision trees, support vector machines, or ensemble models, and may be configured to perform tasks such as classification, regression, clustering, anomaly detection, or data generation. A machine learning model may operate on structured, unstructured, or multimodal data and may generate outputs that are used for predictions, decisions, or content generation based on learned representations of input data.

Additionally, the term “neural network” refers to a computational model comprising multiple interconnected processing elements, often referred to as neurons or nodes, that are organized into layers, including an input layer, one or more hidden layers, and an output layer. Each neuron in the neural network applies a transformation, which may include a weighted sum of inputs followed by a non-linear activation function, to produce an output that is transmitted to subsequent neurons in the network. Neural networks are configured to learn representations of data by adjusting the weights and biases of the connections between neurons during a training process that minimizes a loss function. The neural network may include various architectures, including but not limited to feedforward neural networks, convolutional neural networks (CNNs), recurrent neural networks (RNNs), and transformer-based networks (e.g., LLMs), and may be utilized for tasks such as classification, regression, pattern recognition, natural language processing, and generative modeling across structured, unstructured, or multimodal data.

As used herein, the term “generative model” refers to a machine learning model that is configured to generate new data samples that are statistically consistent with the data on which the model was trained. Generative models may include, but are not limited to, large language models, diffusion models, variational autoencoders, generative adversarial networks, and multimodal transformer models. Generative models may be configured to generate outputs across various modalities, including text, images, audio, and video, either independently or conditionally based on input data from the same or a different modality. For example, a generative model may generate an image based on a textual prompt, generate speech based on textual input, or generate text based on prior conversational context, and may operate using probabilistic or iterative denoising methods to produce high-quality, contextually appropriate outputs.

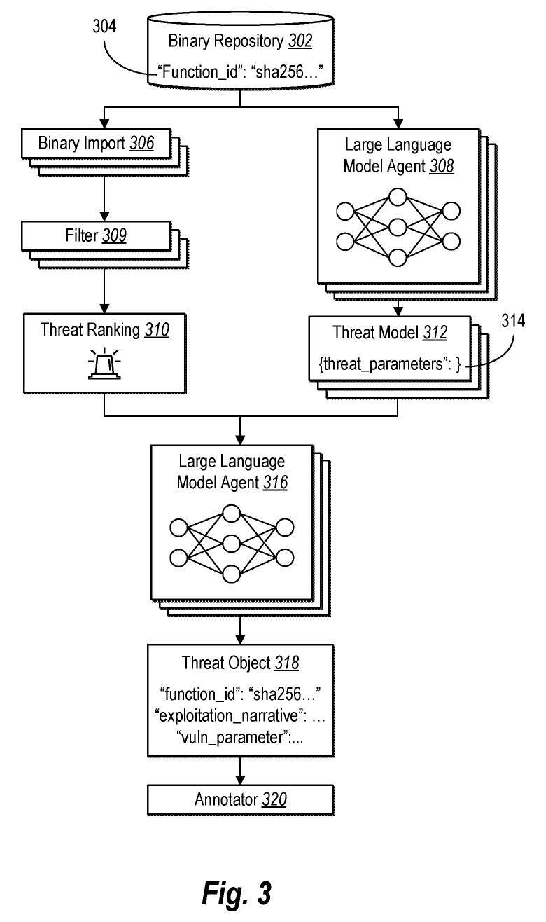

As mentioned above, the generative AI system 100 can detect vulnerabilities associated with changes to computer code in a computer application. FIG. 3 illustrates an example overview of a binary threat detection system generating a threat object in accordance with one or more embodiments. Additional detail regarding the acts and processes introduced in relation to FIG. 3 is provided thereafter with reference to subsequent figures.

As shown in FIG. 3, the generative AI system 100 (or the binary threat detection system 200) can scan one or more binary functions (e.g., a large repository of millions of binary functions) comprising a binary function 304 within a binary repository 302. In some cases, the binary function 304 can correspond to a piece or snippet of code that performs a task (e.g., parse a request or encrypt data) within the computer application. As indicated above, the binary threat detection system 200 can store one or more binary functions related to a computer application in the binary repository 302. For example, the binary repository 302 can include a list, directory, index, etc., comprising artifacts associated with the computer application. To further illustrate, the binary repository 302 can comprise binary functions, instrumented bundles, decompiles, call graphs, metadata, indexes, caches, etc., associated with the computer application.

In one or more implementations, the binary threat detection system 200 can generate one or more isolated containers to import (e.g., a binary import 306) the one or more binary functions from the binary repository 302. In one or more cases, the binary threat detection system 200 can utilize a control plane orchestrator to determine when to generate (or launch) isolated containers during steps (or stages) for determining binary functions associated with vulnerabilities within the computer application. In some cases, the isolated container is an ephemeral and/or short-lived container and/or a container as a service (CaaS) container.

In some cases, the binary threat detection system 200 can perform function splitting on the one or more binary functions or generate binary function fragments of the one or more binary functions from the binary repository 302. For example, the binary threat detection system 200 can utilize a reverse-engineering framework (e.g., Ghidra) to generate—or dissect a binary function into—binary function fragments. Based on the vast amounts of data in the binary repository 302, and as shown in FIG. 3, the binary threat detection system 200 can utilize several agents, large language model agents, filters, threat models, and/or threat rankings within a plurality of isolated containers to, in parallel, import, filter, rank, and/or analyze all of the one or more binary functions (or binary function fragments) stored in the binary repository 302.

As shown in FIG. 3, in one or more cases, the binary threat detection system 200 can apply a filter 309 to the one or more imported binary functions. In particular, the binary threat detection system 200 can remove trivial or stub functions that are uninteresting or do not pose much of a threat to the source code of a computer application. As indicated above, in one or more cases, the binary threat detection system 200 can generate a plurality of filters and apply the plurality of filters to binary function fragments within isolated containers concurrently to efficiently identify relevant binary functions (or binary function fragments) that lead to one or more vulnerabilities. In some embodiments, during hydration or re-hydration of objects, the workers (or agents) within the isolated container inherit an accumulated state of the binary functions, call graphs, and/or threat objects stored in the content-addressable store.

Continuing the discrete phases of the control plane, the binary threat detection system 200 can generate a remote procedure call (RPC) bridge to a reverse-engineering framework, such as Ghidra, so that the reverse-engineering framework can hydrate (or re-hydrate) artifacts or outputs (e.g., objects) for various stages of analysis, run one or more analyses (or scripts), and/or export analysis artifacts or outputs in a resume-capable format. The binary threat detection system 200 can utilize the RPC bridge to facilitate staged analysis of the binary function 304 within isolated containers. For example, the binary threat detection system 200 can utilize the reverse-engineering framework to enumerate the binary function 304 and/or the one or more binary functions and apply a filter to remove one or more trivial binary functions (e.g., procedure linkage tables, linkage stubs, tiny thunks, etc.) from the one or more binary functions.

Further continuing the orchestration logic of the control plane, the binary threat detection system 200 can generate a call graph of the one or more binary functions (e.g., non-trivial binary functions). In particular, the binary threat detection system 200 can generate, via the control plane orchestrator and/or the reverse-engineering framework, a plurality of isolated containers and generate a plurality of bounded (or segmentized) call graphs within the plurality of isolated containers. For example, the binary threat detection system 200, via the control plane orchestrator, can segmentize (or chunk) the one or more binary functions into bounded code segments and generate one or more bounded (or segmentized) call graphs based on a subset of binary functions associated with the bounded code segments. Additionally, the binary threat detection system 200 can generate a call graph (or merged call graph) by combining the one or more bounded call graphs. As described in more detail below, the binary threat detection system 200 generates artifacts (e.g., enumerated functions, bounded call graphs, the call graph (or merged call graph), project bundles, etc.), the binary threat detection system 200 can export or cache the artifacts to a content-addressable store so that the binary threat detection system 200 can hydrate (or re-hydrate) the artifacts for downstream use. In some cases, the content-addressable store can be a cloud-based or air-gapped environment. In one or more cases, the content-addressable store can be locally-based.

As just mentioned, as part of the orchestration logic of the control plane, the binary threat detection system 200 can utilize the RPC bridge and the reverse-engineering framework to perform an initial threat analysis of the binary function 304 and/or the one or more binary functions within the binary repository 302. In one or more cases, the reverse-engineering framework can apply one or more heuristics and/or a large language model (or large language model agent) to determine a threat ranking 310 for the binary function 304. For example, the binary threat detection system 200 can hydrate (or re-hydrate) the one or more bounded call graphs in the one or more isolated containers and apply a heuristic analysis to the segmented binary functions to generate the threat ranking 310. In some cases, the threat ranking 310 can correspond to a score, likelihood, or label indicating the potential or degree of threat associated with the binary function 304 and/or the segmented binary functions.

As further shown in FIG. 3, the binary threat detection system 200 can utilize a large language model agent 308 associated with or within the generative AI system 100 to generate a threat model 312. In one or more cases, the large language model agent 308 can scan or analyze the binary function 304 and/or binary repository and utilize a threat prompt to generate the threat model 312 comprising a structured data object that defines the threat parameters 314 associated with the computer application. In some cases, the threat parameters 314 of the threat model 312 can define likely attack surfaces, relevant vulnerability classes, and/or threat prioritization criteria related to the binary function 304 and/or the computer application.

As further shown in FIG. 3, and continuing the orchestrated phases of the control plane, the binary threat detection system 200 can utilize the binary function 304, based on the threat ranking 310, and the threat model 312 to generate a threat object 318. In particular, the binary threat detection system 200 can utilize a large language model agent 316 (or large language model agent) to analyze the binary function 304 together with the threat model 312 to determine if the binary function 304 exposes the computer application to various threats and/or security risks. For example, the large language model agent 316 can utilize the threat model 312 to provide context that informs or helps the large language model agent 316 to detect a vulnerability associated with the binary function 304 and determine the severity or exploitability of the vulnerability associated with the binary function and/or a likelihood of the vulnerability being leveraged by a bad actor and/or an external artificial intelligence agent. In some cases, the binary threat detection system 200 can prioritize the vulnerability associated with the binary function 304 based on the type or exploitability of the vulnerability.

As FIG. 3 illustrates, the large language model agent 316 can generate a threat object 318 indicating threat data associated with the binary function 304. For example, the threat object 318 can include a description or summary of the vulnerability associated with the binary function 304. In some cases, the threat object 318 can identify the status, vulnerability class, function, impact, exploitation narrative, evidence, etc., of the vulnerability associated with the binary function 304. For example, if the binary function 304 corresponds to an unauthenticated user reaching a process request, the binary threat detection system 200 can determine that the binary function 304 leads to a vulnerability that opens the computer application to risks or threats. Additionally, the threat object 318 can identify the binary function 304, provide a list of assumptions that must hold for the bad actor to exploit the vulnerability, and/or the impact of the bad actor exploiting the vulnerability. In some cases, the threat object 318 can include recommended actions for addressing the vulnerability associated with the threat object 318. Moreover, the threat object 318 can be a JSON artifact comprising the threat data. FIG. 3 illustrates, the binary threat detection system 200 utilizing a large language model to perform various stages of analysis of the binary function. In one or more embodiments, the binary threat detection system 200 can utilize AI models (or agents) and/or machine-learning models (or agents) to generate the threat model, call graphs, threat ranking, etc.

In one or more embodiments, the binary threat detection system 200 can further annotate the threat object 318 with an annotator 320. In one or more cases, the annotator 320 can label the threat data within the threat object 318. For example, the annotator 320 can provide details and/or context about the threat object 318. In one or more cases, the binary threat detection system 200 can send an annotated threat object to a content-addressable store (or global knowledge store). In some cases, the binary threat detection system 200 can deconflict and/or deduplicate conflicting data from large language model agents (or large language models). For example, the binary threat detection system 200 can resolve conflicting data of a first threat object from a first large language model agent analyzing the binary function 304 and a second threat object from a second large language model agent analyzing the binary function 304. In some cases, deduplication can resolve redundant or conflicting operations deterministically under policy. In one or more cases, the binary threat detection system 200 can store the resolved and/or most recent threat object as a current worldview of the binary function 304. If a third large language model agent needs to analyze information relating to the binary function 304, the binary threat detection system 200 can pull and rehydrate the most recent object (or artifact) associated with the most current threat object for additional downstream analysis.

In some embodiments, the binary threat detection system 200 can implement stigmergic coordination among large language model agents, wherein agents indirectly coordinate through the content-addressable store by observing, producing, and/or updating shared artifacts (or artifacts) or shared objects (or objects). For example, one or more large language model agents can read and/or write shared artifacts and/or shared objects (or objects) through the content-addressable store by utilizing one or more stigmergic agentic algorithms. To further illustrate, in one or more cases, each large language model agent can write deterministic artifacts as objects to the content-addressable store. Relatedly, the one or more additional large language model agents can observe one or more artifacts (or objects) and determine when to merge, rank, decompile, validate, etc. existing, additional, and/or new artifacts (e.g., shared artifacts) or objects stored in the content-addressable store utilizing the stigmergic agentic algorithms. Thus, the binary threat detection system 200, via stigmergic coordination, enables decentralized task allocation and conflict resolution without requiring direct inter-agent communication.

As suggested above, the binary threat detection system 200 can provide security improvements over existing systems. For example, the binary threat detection system 200 isolates vulnerability analysis from a control plane by executing untrusted binary processing inside ephemeral containers with workers that hydrate only the minimal, content-addressed objects (object or artifacts) required for a task and by using short-lived, scoped credentials (e.g., time-limited access tokens) for artifact access. This separation prevents prompt injection and other contamination of orchestration logic, reduces the risk of secret or binary leakage into the control plane, and ensures that model prompts and decision logic remain untampered. Moreover, the binary threat detection system 200 provides improved explainability to aid in vulnerability triage. For example, unlike existing systems that generate opaque, one-off scanner outputs, the binary threat detection system 200 can generate a threat object with an exploitation narrative that identifies exploitable vulnerabilities by identifying actual call paths, locations, and/or sources associated with a binary function that opens the computer application to attacks or data leaks.

On top of enhanced security, the binary threat detection system 200 provides increased flexibility relative to existing systems. Rather than relying on brittle source-level parsers or per-language rules, the binary threat detection system 200 operates on normalized binary artifacts (e.g., binary functions) exposed through a remote procedure call (RPC) bridge and feature extraction layer, enabling language- and platform-agnostic analysis across stripped binaries, mixed architectures, and third-party components. The binary threat detection system 200 can utilize a modular technique (including chunking, deterministic ranking, decompilation, large language model analysis, and validation) so inputs (or components) may be swapped, tuned, or upgraded independently; this architecture allows the binary threat detection system 200 to adapt to evolving toolchains and heterogeneous environments without extensive per-project retuning.

In addition to security and flexibility benefits, the binary threat detection system 200 improves computational efficiency compared to conventional approaches. The binary threat detection system 200 performs a fast, deterministic one-pass ranking that extracts inexpensive static features and call-graph signals to identify a small, high-value candidate set of binary functions. The binary threat detection system 200 can save computing resources by applying expensive operations such as full decompilation, symbolic checks, and large language model analysis to that prioritized subset of binary functions. Moreover, the content-addressable caching of analyzed bounded code segments (or bundles), segmented (or chunked) exports, and incremental uploads eliminates redundant recomputation, reduces large language model inference expense, and concentrates heavy computation power where it is most likely to yield actionable results.

Finally, the binary threat detection system 200 also enhances scalability and robustness through a containerized, chunked execution framework. For example, the binary threat detection system 200 prevents single long-running processes from exhausting resources by sharding inputs (e.g., binary functions) into short-lived, parallel tasks (call-graph slices, function batches, decompile jobs) with deterministic failure semantics, per-task timeouts, and independent retries. Indeed, the merged and/or pruned call-graph and per-chunk retry strategy enable predictable throughput and simple autoscaling, reduce tail latency, and allow failed chunks to be recovered without redoing whole-program analysis.

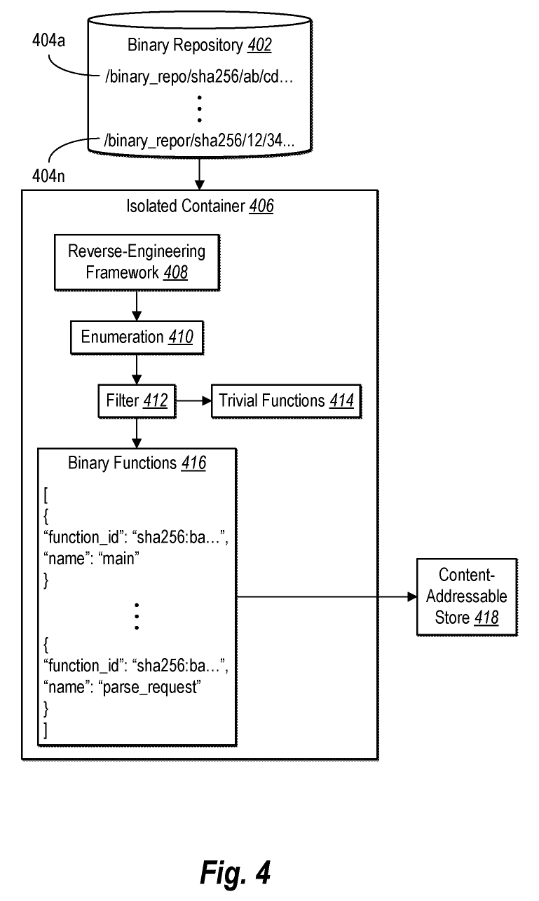

As just discussed, the binary threat detection system 200 can detect vulnerabilities within computer code. In particular, the binary threat detection system 200 can utilize binary functions associated with the computer code to identify and/or expose bugs that open the computer code to security risks. In one or more cases, the binary threat detection system 200 can enumerate and filter binary functions from the binary repository to select (or prioritize) binary functions for further vulnerability analysis. FIG. 4 illustrates the binary threat detection system 200 enumerating and filtering binary functions in accordance with one or more embodiments.

As shown in FIG. 4, the binary threat detection system 200 can scan a binary repository 402 that stores one or more binary functions 404a-n. As indicated above, the binary repository can include binary data (or program artifacts) associated with a computer application. As shown in FIG. 4, the binary threat detection system 200, via a control plane orchestrator, can scan the one or more binary functions 404a-n by launching an isolated container 406. Relatedly, based on the size of the binary repository 402, the binary threat detection system 200can generate a plurality of subsets of binary functions from the one or more binary functions 404a-n and launch, via the control plane orchestrator, a plurality of isolated containers comprising workers (or agents) for parallel analysis. For example, the binary threat detection system 200 can analyze the plurality of subsets of binary functions in the plurality of isolated containers so that a reverse-engineering framework 408 can quickly and efficiently enumerate and filter (or pre-filter) the one or more binary functions 404a-n in parallel. Accordingly, in some cases, the binary threat detection system 200 can generate a subset of binary functions (or a first subset of binary functions) for the isolated container 406 (or first isolated container).

As just mentioned, the binary threat detection system 200 can input the first subset of binary functions into the isolated container 406. In one or more cases, the binary threat detection system 200 can launch the reverse-engineering framework 408 within the isolated container 406, and the binary threat detection system 200 can import the first subset of binary functions into the reverse-engineering framework 408. For example, the binary threat detection system 200 can import the first subset of binary functions into a persistent and/or headless reverse-engineering framework 408 (e.g., Ghidra) project. In some cases, during the import, the binary threat detection system 200 can instruct the reverse-engineering framework 408 not to automatically run an in-depth analysis on the first subset of binary functions to support an efficient initial analysis of the first subset of binary functions.

As further shown in FIG. 4, the binary threat detection system 200 can utilize the reverse-engineering framework 408 to perform enumeration 410 on the first subset of binary functions. For example, the binary threat detection system 200, via the reverse-engineering framework 408, can run one or more scripts (e.g., ListFunc.java) and/or tools to collect (or recover) a start address, name, size, section, etc., for each binary function within the first subset of binary functions. Based on the enumeration 410, the binary threat detection system 200 can generate an enumerated list of the first subset of binary functions and corresponding metadata.

As further shown in FIG. 4, the binary threat detection system 200, via the reverse-engineering framework 408, can apply a filter 412 (or pre-filter) to the first subset of enumerated functions. In particular, the binary threat detection system 200 can apply the filter 412 to remove one or more trivial binary functions 414 from the first subset of binary functions (or set of enumerated binary functions). For example, the binary threat detection system 200 can remove binary functions for procedure linkage tables (PLTs), linkage stubs, tiny thunks (e.g., small wrapper functions), and/or other binary functions that impede downstream analysis. In some implementations, the binary threat detection system 200 can generate the enumerated binary functions utilizing a JSON format (e.g., functions.json or Newline Delimited JSON).

As further shown in FIG. 4, the binary threat detection system 200 can generate a pre-filtered, enumerated list of binary functions 416 from the first subset of binary functions that the binary threat detection system 200 can utilize for additional downstream analysis. For example, in one or more cases, the binary threat detection system 200 can store the enumerated list of binary functions 416 (or the reverse-engineering framework project) as an object in a content-addressable store 418 (e.g., S3, Azure, GCS). For example, the binary threat detection system 200 can store a set of enumerated binary functions as an Azure blob (or object) on the Azure Blob Storage framework. As described in more detail below, the binary threat detection system 200 can store various objects as blobs on Azure Blob Storage. In one or more cases, an agent or worker within the isolated container 406 can request, from the control plane orchestrator, a time limited-access token (e.g., short-lived permission or temporary upload path) to write an archive file comprising the pre-filtered, enumerated list of binary functions 416 to the content-addressable store 418. In one or more cases, the binary threat detection system 200, via the control plane orchestrator, can generate the time limited-access token by generating a short-lived shared access signature URL. Relatedly, the worker can utilize the time-limited access token to upload the pre-filtered, enumerated list of binary functions 416 (or the Ghidra project) to the content-addressable store 418 as the object (or blob). In one or more cases, the control plane orchestrator and/or the worker can verify a file hash (e.g., sha256) associated with the object (or blob) within the content-addressable store 418, and the binary threat detection system 200, via the control plane orchestrator, can generate a versioned worldview (or canonical hash) (e.g., sha256:<hash>) associated with the object (or blob) and store the versioned worldview (or canonical hash) within the archive file (e.g., ghidra.tgz) so that the binary threat detection system 200 references (or points to) the object (or blob) in subsequent analysis steps. In one or more cases, the binary threat detection system 200 can rehydrate the archive file (e.g., Ghidra.tgz) to utilize outputs and/or artifacts in downstream analysis without needing to reprocess (e.g., re-enumerate, re-filter, etc.) the binary functions.

As indicated above, the binary threat detection system 200 can perform the above-described steps in a plurality of isolated containers. In some cases, the binary threat detection system 200 can determine the number of isolated containers and the size of the subsets of binary functions. For example, the binary threat detection system 200 can generate 50 containers that each analyze a subset of 50 binary functions. In one or more cases, the binary threat detection system 200 can determine the number of isolated containers and/or the size of the subsets of binary functions based on the size of the binary repository 402. In some cases, the binary threat detection system 200 can generate hundreds to billions of isolated containers that can process subsets of binary functions in parallel. In some cases, the number of binary functions within the subsets of binary functions can range from 5 binary functions to billions of binary functions. Alternatively, in one or more cases, the binary threat detection system 200 can utilize a single isolated container to enumerate and pre-filter the one or more binary functions 404a-n in the binary repository 402.

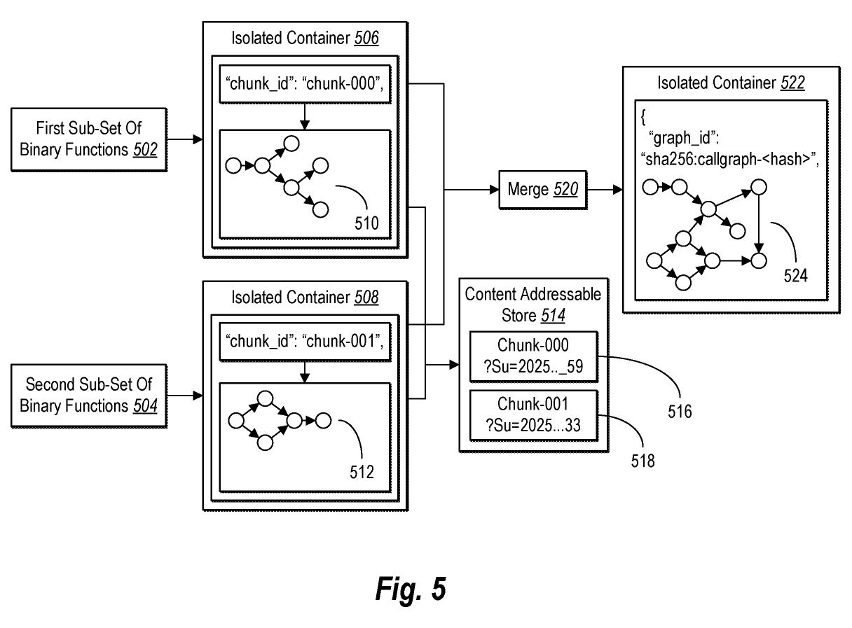

As just discussed, the binary threat detection system 200 can enumerate and/or pre-filter one or more binary functions. In one or more cases, the binary threat detection system 200 can generate a call graph (or merged call graph) based on the enumerated and pre-filtered binary functions. FIG. 5 illustrates the binary threat detection system 200 generating a call graph in accordance with one or more embodiments.

As FIG. 5 illustrates, the binary threat detection system 200 can generate a first call graph 510 for a first subset of binary functions 502 and a second call graph 512 for a second subset of binary functions 504. In one or more cases, the binary threat detection system 200 can determine the size or number of binary functions within the first subset of binary functions 502 and/or the second subset of binary functions 504 based on the size of the binary repository. For example, the first subset of binary functions 502 and the second subset of binary functions 504 can include 200 binary functions. In some cases, the binary threat detection system 200 can determine the size of the binary functions based on the number of isolated containers. Relatedly, in one or more embodiments, the binary threat detection system 200 can receive one or more user inputs defining the size of the first subset of binary functions 502 and/or the second subset of binary functions 504.

As shown in FIG. 5, the binary threat detection system 200 can generate a first isolated container 506 and a second isolated container 508. In one or more cases, the binary threat detection system 200 can re-hydrate the first isolated container with data associated with a first object (or blob) reflecting a first subset of binary functions 502 (e.g., enumerated binary functions) stored in a content-addressable store. For example, the binary threat detection system 200 can re-hydrate a project artifact (or ghidra.tgz) from the content-addressable store. In one or more embodiments, a worker within the first isolated container 506 can request, from a control-plane orchestrator, a first time-limited access token to retrieve the first subset of binary functions 502 associated with the first object stored in a content-addressable store.

In response, the binary threat detection system 200, via the control plane orchestrator, can authorize the request and return the first time-limited access token with a short time to live (TTL) (e.g., 5-30 minutes) to the worker. In one or more cases, the binary threat detection system 200 can utilize the first time-limited access token to download the first subset of binary functions 502 into a local cache associated with the worker. In one or more cases, the worker can notify the control plane orchestrator of a successful or unsuccessful download of the first subset of binary functions 502. As indicated in FIG. 5, the binary threat detection system 200 can perform the same aforementioned steps (e.g., re-hydrating a second project artifact or second object) for a second subset of binary functions 504 in a second isolated container 508 with a second worker associated with the second isolated container 508.

As further shown in FIG. 5, the binary threat detection system 200 can generate a first call graph 510 associated with the first subset of binary functions 502. In one or more cases, the binary threat detection system 200 can utilize a reverse-engineering framework with the first worker (or agent) within the first isolated container 506 to generate the first call graph 510 comprising nodes representing the binary functions and edges representing calls (or connections) between the nodes (or binary functions) from the first subset of binary functions 502. In one or more cases, the reverse-engineering framework can analyze the first subset of binary functions 502 to discover cross-references and/or function calls between the first subset of binary functions 502 utilizing an export instruction (e.g., ExportCallgraphChunk.java). In one or more cases, the binary threat detection system 200 can run the export instruction in parallel across the first isolated container 506 and the second isolated container 508. For example, the binary threat detection system 200 can generate a second call graph 512 associated with the second subset of binary functions 504 in the second isolated container 508.

In one or more embodiments, the binary threat detection system 200 can perform taint analysis on the first call graph 510 and/or the second call graph 512. For example, the binary threat detection system 200 can label (or annotate) the first call graph 510 and/or the second call graph 512 with one or more taint attributes. For example, the binary threat detection system 200 can utilize a large language model agent (or large language model) to label whether the binary function (or code segment) is a source, a sink, or call path (or data flow) that feeds tainted data from a source to a sink.

As further shown in FIG. 5, in one or more cases, the binary threat detection system 200 can export the first call graph 510 (or first Ghidra project) and/or the second call graph 512 (e.g., second Ghidra project) to a content-addressable store 514 as a first bounded code segment 516 and a second bounded code segment 518. As described above, the binary threat detection system 200 can stage (or store) the first bounded code segment 516 as a first object within the content-addressable store 514 for additional downstream analysis.

In one or more cases, the binary threat detection system 200 can avoid resource exhaustion and increase the speed of processing the binary functions within the binary repository by merging partial call graphs representing subsets of binary functions. For example, as shown in FIG. 5, the binary threat detection system 200 can merge 520 the first call graph 510 and the second call graph 512 to generate a call graph 524 (or a merged call graph) reflecting all of the pre-filtered and enumerated binary functions within the binary repository. In particular, the binary threat detection system 200 can initiate a third isolated container 522 and fetch the first call graph 510 and the second call graph 512 based on hydrating (or re-hydrating) the first object (or first Ghidra project) corresponding to the first bounded code segment 516 and the second object (or second Ghidra project) corresponding to the second bounded code segment 518 from the content addressable store 514 as described above.

In one or more cases, during the merge 520, the binary threat detection system 200 can utilize the reverse-engineering framework to stitch the first call graph 510 and the second call graph 512 together, remove duplicate nodes and/or edges, and/or reconcile addresses between binary functions. For example, in one or more cases, the binary threat detection system 200 can utilize a deconfliction step to resolve any conflicts between the first call graph 510 and the second call graph 512. Thus, the binary threat detection system 200 can generate a merged and pruned version (or versioned world view) of the call graph 524 reflecting relationships, connections, function callers, function callees, etc., of the interesting and/or relevant binary functions in the binary repository that expose a computer application to vulnerabilities. In one or more cases, the call graph 524 can include trivial nodes based on one or more user inputs directing the binary threat detection system 200 to include the trivial nodes.

In some cases, the binary threat detection system 200 can export the call graph 524 as an object (or Ghidra project) on the content-addressable store 514. Accordingly, the binary threat detection system 200 can utilize the object of the call graph 524 as a versioned world view (or canonical source) for further analysis. In some cases, the binary threat detection system 200 can generate a progress indicator showing the progress of generating the call graph 524. In one or more cases, the binary threat detection system 200 can generate an observability index or log outlining the steps and/or actions taken by the reverse-engineering framework. As described above, the binary threat detection system 200 can cache various outputs (e.g., objects, artifacts, projects) in the content-addressable store 514. In one or more cases, by tracking progress of the vulnerability analysis stages and caching various outputs at those stages, the binary threat detection system 200 supports incremental vulnerability analysis that enables mid-run resumes without losing progress.

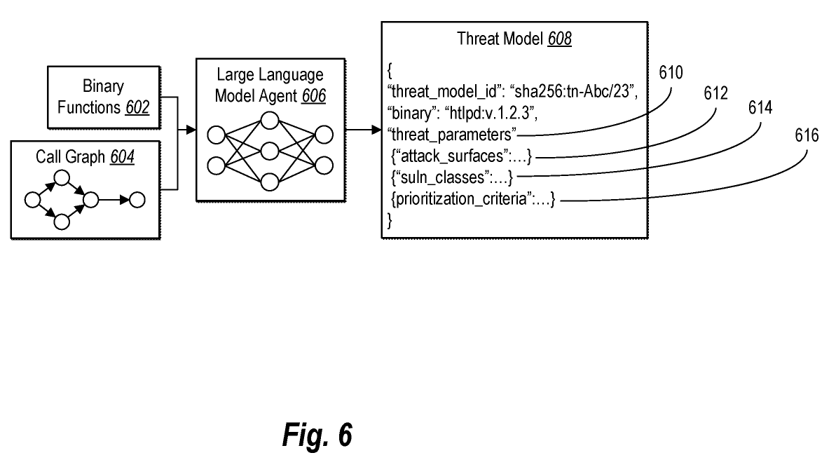

As discussed, the binary threat detection system 200 can generate a call graph representing the binary functions in a binary repository. As described in more detail below, the binary threat detection system 200 can utilize a threat model to analyze the one or more binary functions throughout annotation, ranking, etc. FIG. 6 illustrates the binary threat detection system 200 generating a threat model utilizing a large language model in accordance with one or more embodiments.

As shown in FIG. 6, the binary threat detection system 200 can provide one or more binary functions 602 and/or a call graph 604 (or segmented call graphs) to a large language model agent 606. In some cases, the large language model agent 606 can utilize and/or perform taint analysis on the call graph 604 to help generate the threat model 608. In one or more cases, the large language model agent 606 can generate a threat model 608 (or threat finding) that defines the threat parameters 610 specific to binary functions. For example, the binary threat detection system 200, via the large language model agent 606, can define relevant (or likely) attack surfaces 612, relevant vulnerability classes 614, and/or threat prioritization criteria 616 tailored to binary functions. For example, the large language model agent 606 can define (or identify) surfaces (or places) where a bad actor can interact with or influence binary functions within the computer application. In one or more embodiments, the attack surfaces 612 can include network ports, file inputs, third-party libraries, command-line interfaces (CLIs), supply chains, etc.

In one or more cases, the binary threat detection system 200 can utilize an external environment to inform the generation of the threat model 608. In particular, the binary threat detection system 200 can utilize the external environment to identify known issues (e.g., attack surfaces and/or vulnerability classes) for a given binary function, the computer code, and/or the computer application. In one or more embodiments, the binary threat detection system 200 can receive, via a client device associated with a user account, user-supplied information identifying issues or vulnerabilities associated with one or more binary functions, and the binary threat detection system 200, via the large language model agent 606, can generate or inform the generation of the threat model 608 based on the user-supplied information.

Additionally, the large language model agent 606 can define the relevant vulnerability classes 614. For example, the large language model agent 606 can define stack buffer overflows, heap buffer overflows, integer overflows, format-string vulnerabilities, authentication bypasses, authorization bypasses, path traversals, information disclosures, etc., as the relevant vulnerability classes 614. Moreover, the large language model agent 606 can outline signals indicating that a binary function from the one or more binary functions 602 corresponds to a given vulnerability class. For example, the binary threat detection system 200 can define an authentication bypass that allows unauthorized actions by an external user account (or agent) and outline signals (e.g., a lack of proper checks) indicating a vulnerability associated with the binary function.

Moreover, the large language model agent 606 can define the threat prioritization criteria 616. In one or more cases, the threat prioritization criteria 616 can be a scoring framework that weighs the importance of vulnerabilities associated with the one or more binary functions 602. For example, the threat prioritization criteria 616 can define how the threat model 608 weighs the severity (or criticality) of the relevant vulnerability classes 614, the likelihood (or reachability) of triggering the vulnerability, the sensitivity of the data (e.g., PII, authentication logic, payment flows, etc.) related to the vulnerability, and/or the exploitability of the vulnerability. To further illustrate, the binary threat detection system 200 can weigh the exploitability of the vulnerability based on the availability and/or knowledge of exploitative techniques.

In one or more cases, the binary threat detection system 200 can receive one or more user inputs modifying the threat model 608, or more specifically, the structured data object defining the threat parameters 610. For example, the binary threat detection system 200 can receive one or more user interactions adding, removing, and/or modifying the relevant attack surfaces 612 and/or the relevant vulnerability classes 614. In one or more cases, the binary threat detection system 200 can receive one or more user inputs modifying the relevant vulnerability classes 614 by adding and/or removing vulnerability classes or signals indicating a vulnerability associated with the relevant vulnerability classes 614. Moreover, the binary threat detection system 200 can receive one or more user inputs (or interactions) modifying the threat prioritization criteria 616 of the threat model 608. For example, the binary threat detection system 200 can receive one or more user interactions increasing and/or decreasing the weights for the severity of the relevant vulnerability classes 614, the likelihood of triggering the vulnerability, the sensitivity of the data, and/or the exploitability of the vulnerability. In one or more cases, based on receiving the one or more user interactions modifying the threat parameters 610, the binary threat detection system 200 can update the threat model 608 and/or the threat parameters 610 of the threat model 608.

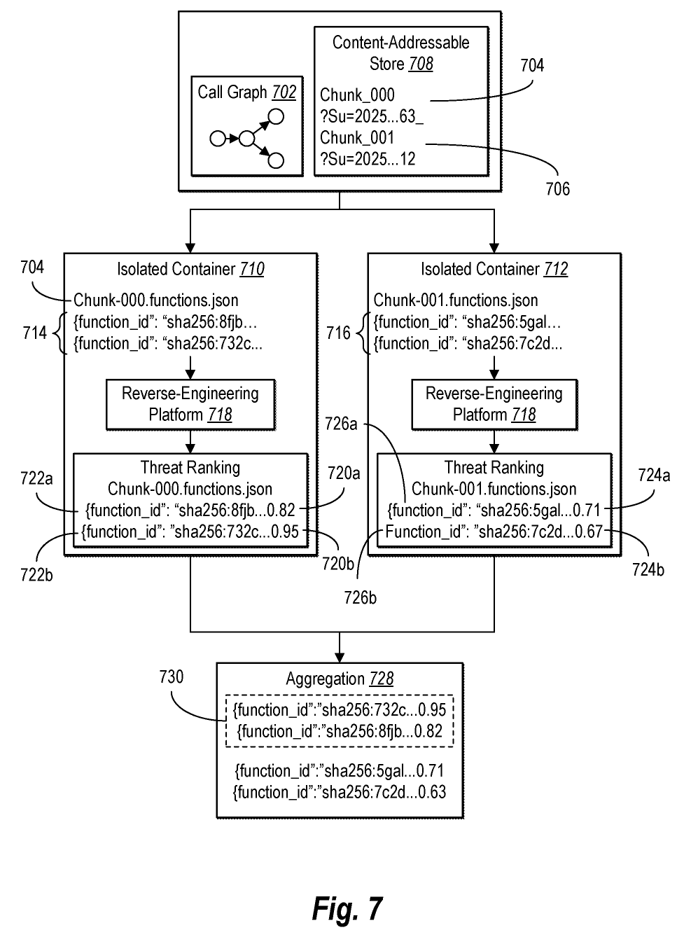

In one or more cases, the binary threat detection system 200 can rank one or more binary functions represented in the call graph as part of an initial threat analysis. FIG. 7 illustrates the binary threat detection system 200 determining threat rankings for one or more binary functions in accordance with one or more embodiments.

As described above, in one or more cases, the binary threat detection system 200 can perform an initial threat analysis to detect interesting or relevant binary functions that can lead to vulnerabilities in a computer application. In one or more cases, determining a threat ranking for a binary function can aid in the speed of detecting vulnerabilities. In one or more cases, the binary threat detection system 200 can utilize a call graph 702 to determine the threat ranking for the binary function. In particular, the binary threat detection system 200 can utilize one or more bounded segments (e.g., a first bounded segment 704 and a second bounded segment 706) associated with bounded (or segmented) call graphs stored as objects in a content-addressable store 708.

As described above, the binary threat detection system 200 can launch fresh isolated containers (e.g., a first isolated container 710 and a second isolated container 712). As shown in FIG. 7, the binary threat detection system 200 can hydrate the first bounded segment 704 associated with a first set of binary functions 714 corresponding to the first bounded call graph in the first isolated container 710 utilizing a first time-limited access token as described above. As shown in FIG. 7, the binary threat detection system 200 can hydrate the second bounded segment 706 associated with a second set of binary functions 716 corresponding to the second bounded call graph in the second isolated container 712 utilizing a second time-limited access token.

As shown in FIG. 7, the binary threat detection system 200 can utilize a reverse-engineering platform 718 to perform a one-pass ranking (e.g., RankFunctions.java) of the first set of binary functions 714 in the first isolated container 710. In one or more cases, the one-pass ranking can analyze one or more inputs and/or features associated with the first set of binary functions 714. For instance, the binary threat detection system 200, via the reverse-engineering platform 718, can weigh sink calls, (e.g., memcpy), format-string patterns, centrality, etc., for the first set of binary functions 714 to determine a first threat ranking 720a for a first binary function 722a and a second threat ranking 720b for a second binary function 722b. In one or more cases, the reverse-engineering platform 718 can utilize one or more heuristics that flag or heavily weigh complicated binary functions, binary functions that utilize memory in interesting ways, binary functions that utilize user data, etc.

In one or more cases, the binary threat detection system 200 can perform the same actions on the second set of binary functions 716 in the second isolated container 712 to determine a third threat ranking 724a for a third binary function 726a and a fourth threat ranking 724b for a fourth binary function 726b from the second set of binary functions 716. As shown in FIG. 7, in one or more cases, the threat ranking can be a numeric score, label, and/or likelihood indicating a level of risk associated with the binary function. For example, a higher threat ranking can indicate a higher likelihood that the corresponding binary function exposes the computer application to a severe vulnerability. In one or more cases, the threat ranking indicates that the binary threat detection system 200 should perform further analysis on the corresponding binary function.

In one or more embodiments, the binary threat detection system 200 can update the heuristics. For example, in some cases, the threat model (or large language model agent) can generate a per-binary function list of terms, calls, and/or strings that increases the threat ranking of a given heuristic. For example, the binary threat detection system 200 can look for a string inside a function associated with a bad actor impersonating a user account. In one or more cases, the binary threat detection system 200 can boost the scoring the corresponding heuristic for that string. Thus, the binary threat detection system 200 can dynamically update how the system determines threat rankings for binary functions.

Relatedly, in one or more cases, if the binary threat detection system 200 cannot rank a binary function based on a missing identifier and/or hydration failure, the binary threat detection system 200 can implement a strict mode that aborts generating an output or performing an analysis step within the isolated container. For example, if the binary threat detection system 200 detects a hydration (or re-hydration) failure of a first call graph associated with the first set of binary functions 714, the binary threat detection system 200, via the control plane orchestrator, can abort generating a first threat ranking 720a for the first binary function 722a. In some cases, if the binary threat detection system 200 detects a failure generating a threat ranking for a binary function, the binary threat detection system 200 can implement a large language model as a backup to generate the threat ranking.

As just indicated, in one or more embodiments, the binary threat detection system 200 can utilize a large language model to generate the threat rankings. For example, the binary threat detection system 200 can utilize a large language model to analyze the first set of binary functions 714 and determine the first threat ranking 720a for the first binary function 722a and the second threat ranking 720b for the second binary function 722b. In one or more cases, the large language model can access a set of tools to determine threat rankings that indicate an initial finding of risk or severity of a vulnerability associated with the binary function.

As shown in FIG. 7, the binary threat detection system 200 can perform an aggregation step 728 that combines the threat rankings across isolated containers. For example, as FIG. 7 illustrates, the binary threat detection system 200 can generate a threat ranking list (e.g., ranked_functions.json) by combining the threat rankings for the first set of binary functions 714 and the second set of binary functions 716. Indeed, the binary threat detection system 200 can aggregate all threat rankings across any number of isolated containers. In some implementations, the binary threat detection system 200 can organize binary functions based on the threat rankings with the binary functions. For example, as shown in FIG. 7, the binary threat detection system 200 can place the binary functions with the highest threat rankings at the top of the threat ranking list.

In one or more cases, the binary threat detection system 200 can select a top subset of binary functions 730 from the threat ranking list. For example, the binary threat detection system 200 can select the top-k binary functions and perform additional analysis on the selected binary functions. To further illustrate, the binary threat detection system 200 can select the top 500 binary functions with the highest threat rankings for further analysis. In some cases, the binary threat detection system 200 can receive one or more user inputs defining the top-k binary functions. In some cases, the binary threat detection system 200 can determine the top-k binary functions based on the size of the binary repository and/or processing time.

As just described, the binary threat detection system 200 can rank the first set of binary functions 714 and the second set of binary functions 716 utilizing one-pass function scoring. In one or more cases, the binary threat detection system 200 can perform an optional decompiling on the top subset of binary functions 730. In one or more cases, the binary threat detection system 200 can further batch (or chunk) the top subset of binary functions 730 into smaller bundles (or bounded code segments). For example, if the top subset of binary functions 730 includes 200 binary functions, the binary threat detection system 200 can partition the 200 binary functions into bounded code segments of 20-50 binary functions. Additionally, the binary threat detection system 200 can launch one or more isolated containers and hydrate the bounded code segments associated with the bounded code segments utilizing a time-limited access token as described above. For example, the binary threat detection system 200 can hydrate the applicable objects (e.g., ghidra.tgz) into the one or more isolated containers.

Moreover, in one or more implementations, the binary threat detection system 200 can apply a decompile script to the bounded code segment of binary functions to generate pseudo-C (e.g., decompiled.json or decompiled.ndjson) of the bounded code segment of binary functions. In one or more cases, the binary threat detection system 200 can decompile batches of binary functions from the top subset of binary functions 730 across one or more isolated containers. As described above, the binary threat detection system 200 can store (or cache) the decompiled binary functions as objects in the content-addressable store.

In some cases, the binary threat detection system 200 can further perform an optional annotation step on the top subset of binary functions 730, as decompiled binary functions or binary functions represented in the call graph. In particular, the binary threat detection system 200 can launch one or more fresh isolated containers and utilize one or more large language models within the one or more isolated containers to generate one or more function summaries (e.g., annotations.json) for each function within the top subset of binary functions 730 or binary functions represented in the call graph. In one or more cases, the annotation step can include enriching analysis artifacts (e.g., binary functions, enumerated binary functions, call graph nodes, decompiled binary functions, etc.) with findings, metadata, and/or links of the top subset of binary functions 730 (or all of the binary functions from the binary repository). For example, the binary threat detection system 200 can generate the function summary that outlines threat parameters (e.g., vulnerability classes, taint sources, sinks, taint flows, etc.) and includes identification information (e.g., function id, address, name, call path ids, etc.) associated with the binary function. As described above, the binary threat detection system 200 can bundle (or chunk) the annotated binary functions and cache the bundles of the annotated binary functions in the content-addressable store as an object (or blob) that can be rehydrated and utilized for further analysis.

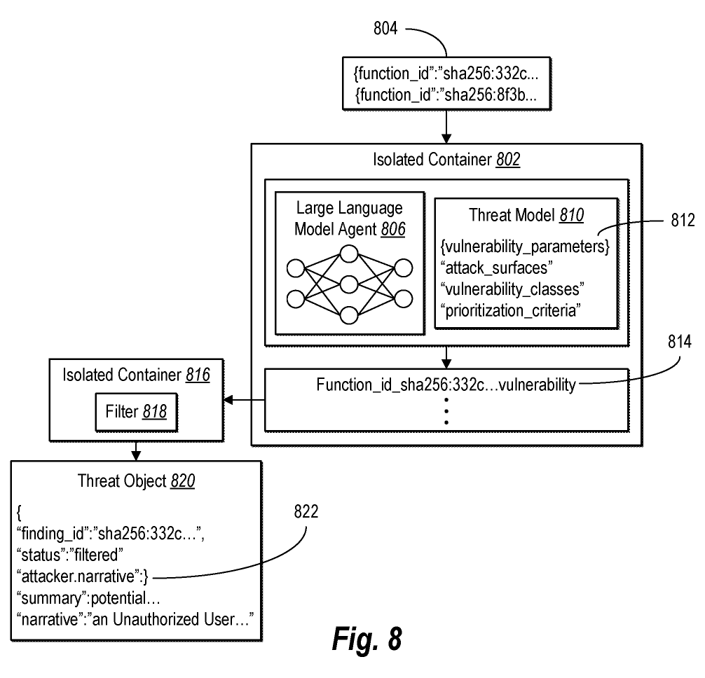

As just discussed, the binary threat detection system 200 can perform an initial threat analysis by importing, enumerating, pre-filtering, and ranking one or more binary functions across various isolated containers. In one or more embodiments, the binary threat detection system 200 can perform additional analysis on relevant and/or interesting binary functions based on the initial threat analysis. FIG. 8 illustrates the binary threat detection system 200 generating a threat object by analyzing a binary function within an isolated container in accordance with one or more embodiments.

As shown in FIG. 8, the binary threat detection system 200 can generate an isolated container 802 for analyzing one or more binary functions 804. In one or more cases, the binary threat detection system 200 can rehydrate an object (or blob) associated with a bounded code segment of binary functions from the content-addressable store. In one or more cases, the binary threat detection system 200 can rehydrate the isolated container 802 with objects cached in the content-addressable store from any of the previous stages of analysis. For example, the binary threat detection system 200 can rehydrate the bounded code segments associated with objects for enumerated binary functions, bounded call graphs, threat rankings, decompiled binary functions, and/or annotated binary functions. Because the binary threat detection system 200 can incrementally store or cache the outputs (e.g., artifacts) in a resume-capable format at each stage of analysis as objects in the content-addressable store, the binary threat detection system 200 seamlessly pause and resume analysis of the one or more binary functions 804 without losing information and without requiring redundant reprocessing of the one or more binary functions 804.

As discussed above, the binary threat detection system 200 can analyze the one or more binary functions 804 (or the top-K binary functions) and the threat model 810 with a large language model agent 806 in the isolated container 802. In one or more cases, the large language model agent 806 can utilize the threat model 810 to provide context to the large language model agent 806 regarding which relevant attack surfaces and/or vulnerability classes to focus on or highlight, and how to prioritize findings. Indeed, the threat model 810 can inform the large language model agent 806 on what to look for while analyzing the one or more binary functions 804 (or the top-K binary). In one or more cases, the large language model agent 806 can analyze the decompiled bounded code segments (or snippets) of the top-K binary functions, the bounded code segments of the merged and/or pruned call graph, and/or the threat ranking data (e.g., one-pass features) associated with the top-K binary functions. In one or more cases, the binary threat detection system 200 can input bounded code segments (or snippets) of the top-K binary functions (e.g., 5-20 binary functions per large language model) into the large language model to reduce computation time and limit computational resources. In some cases, the binary threat detection system 200 can input any number of binary functions into the large language model agent 806.

In one or more implementations, the large language model agent 806 can utilize a set of tools and the context from the threat model 810 to detect one or more vulnerabilities associated with the one or more binary functions 804. For example, the large language model agent 806 can determine one or more call paths associated with the one or more binary functions 804 that expose the binary threat detection system 200 to one or more vulnerabilities. For example, the binary threat detection system 200, via the large language model agent 806 and the threat model 810, the binary threat detection system 200 can detect and/or determine a plurality of user input flows directed to vulnerable code regions. Accordingly, the binary threat detection system 200 can utilize the threat model 810 and the one or more threat parameters 812 to highlight the relevant attack surfaces and/or vulnerability classes associated with the one or more binary functions 804 that expose the computer application to one or more vulnerabilities. For example, the binary threat detection system 200 can determine if a call path between source (e.g., network-read handler) and sink (e.g., memory-copy functions) is tainted or exposes the computer application to threats from bad actors.

In some cases, the large language model agent 806 can further generate an exploitation narrative 822 outlining one or more steps for exploiting a vulnerability associated with a binary function from the one or more analyzed binary functions 814. For example, the exploitation narrative 822 can identify a source, call path, and impact of a bad actor (or agent) leveraging the vulnerability associated with the binary function. To further illustrate, the large language model agent 806 can utilize reasoning to generate one or more scenarios (or exploitation paths) indicating how a given vulnerability (or bug) might be exploited in practice by tracing user inputs through call paths (or program paths) to the location of the vulnerability (or bug). For example, the binary threat detection system 200 can generate, utilizing the large language model agent 806, a plurality of candidate exploitation narratives associated with the plurality of candidate user input flows mentioned above. In some cases, the binary threat detection system 200 can apply a filter, as described in more detail below, to the plurality of candidate exploitation narratives to remove duplicate and/or unlikely candidate exploitation narratives.

As indicated above, the binary threat detection system 200 can generate exploitation narratives for the one or more analyzed binary functions 814. In some cases, the binary threat detection system 200 can validate the one or more analyzed binary functions 814 by applying a deterministic validator over the one or more analyzed binary functions 814 to confirm features and/or attributes (e.g., exploitation narratives, sources, sinks, call paths, etc.) associated with the one or more analyzed binary functions 814. Indeed, unlike existing systems, the binary threat detection system 200 can bridge the gap between potential vulnerabilities and actual exploitable ones.

In one or more cases, the binary threat detection system 200 can generate incremental outputs of the binary functions from the large language model agent 806. For example, the binary threat detection system 200 can append each analyzed binary function as one NDjson line to a local analyzed_functions.ndjson file. In some cases, the binary threat detection system 200 utilizes a resume-capable format for the analyzed binary functions by generating incremental outputs. As described above, in one or more cases, the binary threat detection system 200 can cache the one or more analyzed binary functions 814 as an object (or blob) in the content-addressable store, where the binary threat detection system 200 can re-hydrate the one or more analyzed binary functions 814 utilizing a time-limited access token as described above. In some cases, the binary threat detection system 200 can generate and cache a list (e.g., analysis_output.json, analyzed_functions) of the one or more analyzed binary functions 814 as an object (or blob) in the content-addressable store.

Additionally, the binary threat detection system 200 can determine the risk associated with the one or more analyzed binary functions 814 as vulnerabilities by generating a threat risk score for a binary function from the one or more analyzed binary functions 814. In particular, the binary threat detection system 200 can utilize the threat model 810 comprising a structured data object defining one or more threat parameters 812 to process the binary function. For example, the binary threat detection system 200 can determine a threat risk score for the binary function based on the one or more threat parameters 812 of the threat model 810. To further illustrate, the binary threat detection system 200 can utilize the threat prioritization criteria of the threat model 810 to apply weights and/or heuristics to the one or more analyzed binary functions 814 to generate the threat risk score for each of the one or more analyzed binary functions 814. For example, the binary threat detection system 200 can utilize the severity, likelihood, reachability, threat ranking, validation results, etc., to generate the threat risk score. In one or more cases, the binary threat detection system 200 can rank the one or more analyzed binary functions 814 according to corresponding threat risk scores and determine a prioritization for addressing the one or more vulnerabilities associated with the one or more binary functions.

In one or more cases, the binary threat detection system 200 can apply a filter 818 to the one or more analyzed binary functions 814. As shown in FIG. 8, the binary threat detection system 200 can launch an isolated container 816 comprising the filter 818. In one or more cases, the filter 818 can be a large language model filter that identifies security-relevant findings from the one or more analyzed binary functions 814. For example, the filter 818 can trace user input paths (or call paths) to vulnerable code regions (or vulnerability surfaces or sites) for the one or more analyzed binary functions 814. In some cases, the filter 818 can detect and remove a subset of binary functions from the one or more analyzed binary functions 814 that duplicate root causes of a vulnerability or have identical call-paths leading to a vulnerability. Thus, the binary threat detection system 200 can generate a set (e.g., filtered_results.json) of filtered and analyzed binary functions associated with vulnerabilities in the computer application.

As shown in FIG. 8, in one or more cases, the 200, via the large language model agent 806, can generate a threat object 820 comprising threat data reflecting the criticality, description, vulnerabilities, and/or bugs related to the binary function from the one or more analyzed binary functions 814. For example, the threat object 820 can include, but is not limited to, a threat object identifier, a binary function summary, an exploitation narrative 822 (or attacker story), information about the vulnerability class (e.g., heap-buffer-overflow), the severity/likelihood of a bad actor leveraging the vulnerability associated with the binary function, a provenance, a historic log, a status, and/or a recommended action (or patch) addressing the vulnerability associated with the binary function. Indeed, the binary threat detection system 200 can generate a structured output (e.g., threat object 820) that makes triaging vulnerabilities faster and easier. As described above, the binary threat detection system 200 can cache the threat object 820 as an object (or blob) in the content-addressable store utilizing a time-limited access token. In one or more cases, the binary threat detection system 200 can cache one or more threat objects generated by one or more isolated containers as objects within the content-addressable store that can be re-hydrated utilizing time-limited access tokens as described above.

In some implementations, the binary threat detection system 200 can generate a JSON artifact of the threat object 820 and post the threat object 820 to a communication channel (e.g., Slack channel), a disk, a web interface, and/or an API. As described in more detail below, in one or more cases, the binary threat detection system 200 can receive one or more user inputs about the findings associated with the threat object 820.

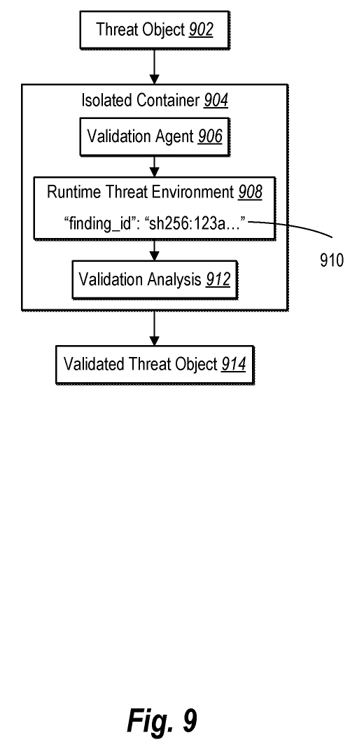

As just described, the binary threat detection system 200 can generate a threat object indicating threat data associated with a binary function. In some cases, the binary threat detection system 200 can validate the threat object before publishing the threat object to the communication channel, the web interface, etc., to confirm the vulnerability associated with the binary function and further understand the impact and risk of the vulnerability associated with the binary function. FIG. 9 illustrates the binary threat detection system 200 validating a threat object utilizing a validation agent in accordance with one or more embodiments.

As shown in FIG. 9, the binary threat detection system 200 can generate an isolated container 904 (or an additional isolated container). In one or more cases, the isolated container 904 is an isolated CaaS container that prevents interference with control-plane code or other environments. Moreover, in some cases, the isolated container 904 is a short-lived, capability-gated container where the validation agent 906 has no access to control-plane code, configurations, and/or secrets. As shown in FIG. 9, the binary threat detection system 200 can analyze a threat object 902 with a validation agent 906 within the isolated container 904. In some cases, the binary threat detection system 200 can utilize external environment information to provide external information about the runtime threat environment 908. In particular, the binary threat detection system 200 can generate a runtime threat environment 908 comprising a binary function 910 by re-hydrating the decompiled binary function object, a call path object, and/or an analyzed binary function object associated with the binary function 910 from the content-accessible store in the isolated container 904.

As further shown in FIG. 9, the binary threat detection system 200 can execute the runtime threat environment 908 and perform validation analysis 912 on the runtime threat environment 908. For example, the binary threat detection system 200 can apply the relevant targeted symbolic checks or a test harness associated with the vulnerability (or bug) and run the runtime threat environment 908 and the binary function 910 under analysis tools (e.g., Valgrind, sanitizers, etc.) to detect one or more vulnerabilities. For example, the validation agent 906 can detect various memory safety errors and non-memory safety errors, such as, but not limited to, buffer overflows, logic flaws, insecure data flows, insecure permission checks, broken access controls, misuse of cryptographic APIs, format-string vulnerabilities, and/or information leaks.

In one or more cases, the binary threat detection system 200 can confirm the existence of the vulnerability associated with the binary function based on the validation agent 906 reproducing the vulnerability in the isolated container 904. For example, the binary threat detection system 200 can determine if the binary function 910 enabled unauthorized actions on the computer application. In one or more cases, the threat detection system 200 can determine if the exploitation narrative of the threat object 902 works within the runtime threat environment 908. The binary threat detection system 200 can generate a validated threat object 914 based on the validation agent 906 confirming the vulnerability associated with the binary function 910.

In one or more cases, the validation analysis 912 can act as a code simulation to compile and run binary functions to test for bugs in the computer application that lead to vulnerabilities. For example, in one or more cases, the validation agent 906 can detect a bug associated with the binary function 910 and included in the threat object 902 that feeds or leads to a vulnerability in the computer application. Thus, the validation analysis 912 can confirm (or verify) the existence of a bug (or one or more bugs) defined in the threat object 902.

In one or more cases, if the validation agent 906 and the validation analysis 912 do not reproduce the vulnerability associated with the cloned version of the binary function 910, the binary threat detection system 200 can mute and/or deprioritize the vulnerability associated with the binary function 910. As indicated above, in one or more cases, the validated threat object 914 can be a structured output comprising threat data (or validated threat data) associated with the binary function 910. For example, the validated threat object 914 can include validation logs, validated exploitation narratives, environment details, etc. In some cases, the validated threat object 914 can include a validation status (e.g., success or failure) indicating confirmation of the vulnerability, along with a summary of the preconditions associated with the vulnerability. As described above, in one or more cases, the binary threat detection system 200 can cache the validated threat object 914 as an object (or blob) in the content-addressable store. In one or more cases, the binary threat detection system 200 can save the validated threat object 914 to a local disk as a JSON and send structured messages and/or reports based on the validated threat object 914 to a chat platform (e.g., Slack), an API endpoint, and/or to a web interface.

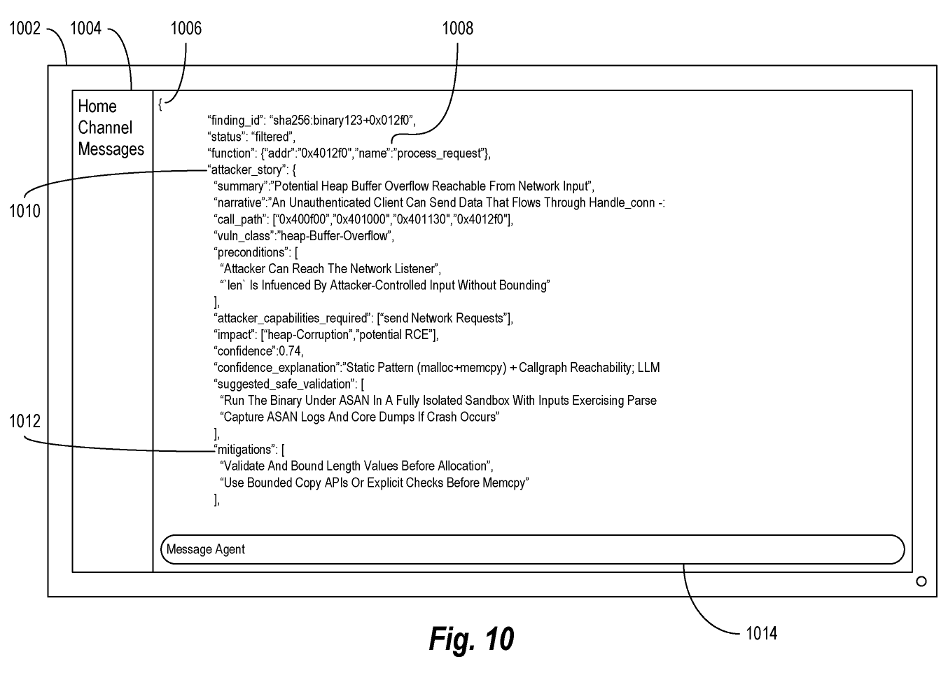

As just discussed, the binary threat detection system 200 can generate a threat object and/or a validated threat object that outlines threat data associated with a binary function. FIG. 10 illustrates an exemplary graphical user interface providing for display a threat object (or validated threat object) in accordance with one or more embodiments. As shown in FIG. 10, the binary threat detection system 200 can provide for display on a graphical user interface 1004 of a client device 1002 a threat object 1006 (or a message associated with the threat object 1006). As shown in FIG. 10, the threat object 1006 can include information identifying a binary function 1008, an exploitation narrative 1010, and/or a recommended action 1012. In one or more cases, the threat object 1006 can include information about the vulnerability class, preconditions, impact, confidence score, etc. Indeed, the threat object 1006 can inform a user account associated with the binary function 1008, the binary repository, and/or the computer application of important information about the vulnerability associated with the binary function 1008.

In one or more cases, the threat object 1006 or (message associated with the threat object 1006) can include evidence about the vulnerability associated with the binary function 1008. For example, the risk score can include a source and sink (or caller/callee) associated with the binary function and/or the call path.

Indeed, the threat object 1006 can provide a human-readable name and a clear summary and/or explanation of the vulnerability and associated binary function 1008. In some cases, the threat object 1006 can indicate the severity or level of risk associated with the vulnerability and the impact of the vulnerability on the affected computer application. In some cases, the threat object 1006 can include an exploitation narrative (or attack story) that includes information about how the vulnerability can be exploited. In one or more cases, the threat object 1006 can indicate the location and whether the vulnerability is validated, unvalidated, patched, unpatched, and/or under review.

As further shown in FIG. 10, the threat object 1006 or (message associated with the threat object 1006) can include a recommended action 1012 for addressing the vulnerability. For example, the binary threat detection system 200 can suggest validations, tests, and/or patches to apply to the binary function to mitigate the risk associated with the vulnerability. For example, the binary threat detection system 200 can generate the recommended action 1012 for addressing heap buffer overflows or memory manipulation routines. In some cases, a validation agent, as described above in FIG. 9, can validate the recommended action 1012 and confirm whether the recommended action 1012 (or fix) addresses the vulnerability.

As further shown in FIG. 10, the binary threat detection system 200 can receive one or more user interactions via an input field 1014. In some cases, the binary threat detection system 200 can support an interactive chat, via a large language model and/or agent (e.g., validation agent), about one or more findings included in the threat object 1006. For example, the binary threat detection system 200 can receive one or more user inputs requesting more information about the exploitation narrative and/or the one or more threat parameters associated with the threat model. In some cases, the binary threat detection system 200 can modify and/or update the threat object 1006 to highlight or include information deemed important by the user account based on receiving the one or more user interactions. In some cases, the binary threat detection system 200 can formulate the threat object 1006 based on the preferences of the user account generating and/or utilizing the threat object 1006.

As indicated above, the binary threat detection system 200 can provide access to the worldview version of the threat object 1006 within a content-addressable store (or global knowledge store). For example, the binary threat detection system 200 can have access to all of the reverse-engineering framework (e.g., Ghidra) tools utilized to analyze the binary functions from the binary repository. Additionally, the binary threat detection system 200 can receive one or more queries and/or prompts that continues reverse engineering of the threat object and/or binary function. For example, the binary threat detection system 200 can receive a query requesting decryption of an object stored on the content-addressable store. The binary threat detection system 200, via the graphical user interface 1004 (or threat object interface) can provide access to the most recent world view of the merged call graph, all of the object, artifacts, tools, analysis, etc., the binary threat detection system 200 utilized to generate the threat object, exploitation narrative, call graph, threat model, etc. For example, the binary threat detection system 200 can generate and/or export a reverse-engineering framework (e.g., Ghidra) compatible database or project (or script bundle) for direct use in the reverse-engineering framework (e.g., Ghidra). In some cases, the binary threat detection system 200 can generate and store operation logs that captures every large language model agent, large language model, and/or worker action in the content-addressable store.

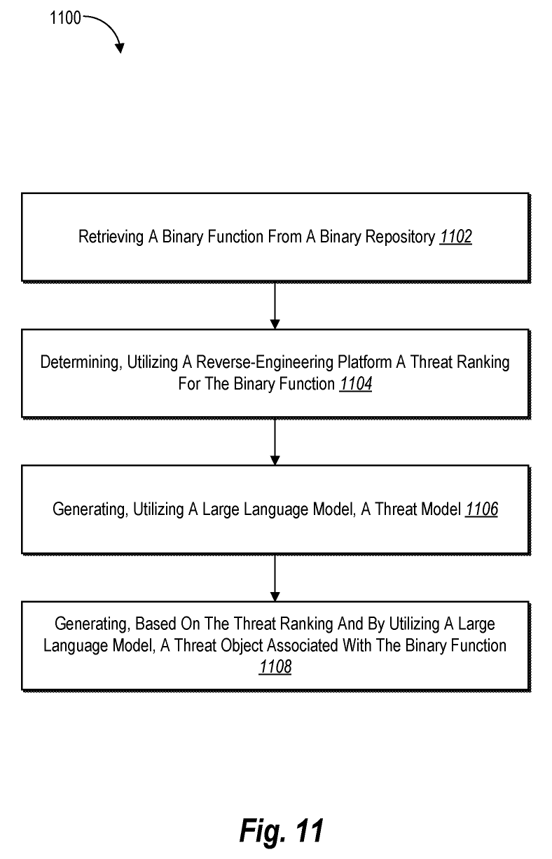

FIGS. 1-10, the corresponding text, and the examples provide a number of different systems and methods for detecting vulnerabilities and potential threats in a binary repository of a computer application based on binary functions associated with computer code for a computer application. In addition to the foregoing, implementations can also be described in terms of flowcharts comprising acts or steps in a method for accomplishing a particular result. For example, FIG. 11 illustrates an example series of acts performed by the binary threat detection system 200 in accordance with one or more embodiments.

While FIG. 11 illustrates acts according to certain implementations, alternative implementations may omit, add to, reorder, and/or modify any of the acts shown in FIG. 11. The acts of FIG. 11 can be performed as part of a method. Alternatively, a non-transitory computer-readable medium can comprise instructions that, when executed by one or more processors, cause a computing device to perform the acts of FIG. 11. In still further implementations, a system can perform the acts of FIG. 11.

As illustrated in FIG. 11, a series of acts 1100 may include an act 1102 of retrieving a binary function from a binary repository, an act 1104 of determining, utilizing a reverse-engineering platform, a threat ranking for the binary function, an act 1106 of generating, utilizing a large language model, a threat model, and an act 1108 of generating, based on the threat ranking and by utilizing a large language model a threat object associated with the binary function.

In particular, the act 1102 includes retrieving, by a generative artificial intelligence (AI) system, a binary function from a binary repository of a computer application. Further, the act 1104 includes determining, utilizing a reverse-engineering platform to perform an initial threat analysis of the binary function, a threat ranking for the binary function. Moreover, the act 1106 includes generating, utilizing a large language model of the generative AI system, a threat model comprising a structured data object defining threat parameters corresponding to the computer application. Additionally, the act 1108 includes generating, based on the threat ranking and by utilizing a large language model to analyze the binary function together with the threat model, a threat object indicating threat data associated with the binary function

Further, in one or more embodiments, the series of acts 1100 includes enumerating, by the reverse-engineering platform, binary functions of the computer application, wherein the binary functions include the binary function from the binary repository. Moreover, in some cases, the series of acts 1100 includes generating a call graph based on enumerating the binary functions.

Additionally, in one or more embodiments, the series of acts 1100 includes generating the threat object by utilizing the large language model in an isolated container, wherein the isolated container prevents the large language model from accessing a control plane associated with the generative AI system.

In one or more cases, the series of acts 1100 includes an act where the threat parameters corresponding to the computer application comprise at least one of relevant attack surfaces of the binary repository, relevant vulnerability classes of the binary repository, or threat prioritization criteria of the threat model.

Moreover, in one or more embodiments, the series of acts 1100 includes caching a threat ranking artifact associated with the binary function in a content-addressable store. In some implementations, the series of acts 1100 includes detecting subsequent analysis related to the binary function associated with the threat ranking artifact. In one or more cases, the series of acts 1100 can include rehydrating the threat ranking artifact for the subsequent analysis related to the binary function.

Additionally, in some implementations, the series of acts 1100 can include incrementally storing one or more outputs associated with analyzing the binary function in a resume-capable format.

Furthermore, in one or more embodiments, the series of acts 1100 includes generating, utilizing the large language model, an exploitation narrative outlining one or more steps for exploiting a vulnerability associated with the binary function.

Moreover, the series of acts 1100 can include retrieving, by a generative artificial intelligence (AI) system, a binary function from a binary repository of a computer application. In some implementations, the series of acts 1100 includes determine, utilizing a reverse-engineering platform to perform an initial threat analysis of the binary function, a threat ranking for the binary function. Additionally, in one or more embodiments, the series of acts 1100 includes generating, utilizing a large language model of the generative AI system, a threat model comprising a structured data object defining threat parameters corresponding to the computer application. Moreover, in one or more embodiments, the series of acts 1100 includes generating, based on the threat ranking and by utilizing the large language model to analyze the binary function together with the threat model, a threat object indicating threat data associated with the binary function. Further, in one or more embodiments, the series of acts 1100 includes generating an exploitation narrative relating to a vulnerability by outlining one or more user input flows to vulnerable code regions associated with the vulnerability of the binary function.

Moreover, in one or more embodiments, the series of acts 1100 includes enumerating a set of binary functions from the binary repository. Further, in one or more embodiments, the series of acts 1100 includes removing trivial binary functions from the set of enumerated binary functions by applying a filter to the set of enumerated binary functions. In some cases, the series of acts 1100 can include generating a call graph based on a remaining subset of enumerated binary functions.

In one or more implementations, the series of acts 1100 includes coordinating at least one of reading or writing of a shared object stored on a content-addressable store by one or more large language model agents utilizing one or more stigmergic agentic algorithms.

Moreover, in one or more embodiments, the series of acts 1100 includes identifying the threat parameters corresponding to at least one of relevant attack surfaces, relevant vulnerability classes, or threat prioritization criteria of the threat model. Further, in one or more embodiments, the series of acts 1100 includes receiving one or more user inputs modifying at least one of the relevant attack surfaces, the relevant vulnerability classes, or the threat prioritization criteria of the threat model. In one or more embodiments, the series of acts 1100 can include updating the threat parameters based on the one or more user inputs.

In some cases, the series of acts 1100 includes caching a threat ranking artifact associated with the binary function in a content-addressable store. Moreover, in one or more embodiments, the series of acts 1100 includes generating a time-limited access token for the threat ranking artifact. Further, in one or more embodiments, the series of acts 1100 includes detecting subsequent analysis related to the binary function associated with the threat ranking artifact. Moreover, in some implementations, the series of acts 1100 includes rehydrating, utilizing the time-limited access token, the threat ranking artifact for the subsequent analysis related to the binary function

Additionally, in one or more embodiments, the series of acts 1100 includes detecting a plurality of candidate user input flows to a plurality of vulnerable code regions. Further, in one or more embodiments, the series of acts 1100 includes generating, utilizing the large language model, a plurality of candidate exploitation narratives associated with the plurality of candidate user input flows. In some implementations, the series of acts 1100 includes filtering, utilizing the large language model, the plurality of candidate exploitation narratives. Moreover, in one or more cases, the series of acts 1100 includes removing duplicate candidate exploitation narratives from the plurality of candidate exploitation narratives.

Further, in one or more embodiments, the series of acts 1100 includes hydrating the binary function associated with the threat object in an isolated container. Additionally, in some implementations, the series of acts 1100 includes detecting one or more threats by analyzing an execution of the binary function. In one or more cases, the series of acts 1100 includes generating a validated threat object indicating a confirmation of the threat data associated with the binary function.

Furthermore, in one or more embodiments, the series of acts 1100 can include generating, by a generative artificial intelligence (AI) system, a call graph mapping binary functions in a binary repository of a computer application. Moreover, in one or more embodiments, the series of acts 1100 includes determining, utilizing a reverse-engineering platform to perform an initial threat analysis of a binary function from the call graph, a threat ranking for the binary function utilizing the call graph. Further, in one or more embodiments, the series of acts 1100 includes generating, utilizing a large language model of the generative AI system, a threat model comprising a structured data object defining threat parameters corresponding to the computer application. Additionally, in one or more implementations, the series of acts 1100 can include generating, based on the threat ranking and by utilizing a large language model to analyze the binary function together with the threat model, a threat object indicating threat data associated with the binary function.

Moreover, in one or more embodiments, the series of acts 1100 includes enumerating a set of binary functions from the binary repository. In some cases, the series of acts 1100 can include removing trivial binary functions from the set of enumerated binary functions by applying a filter to the set of enumerated binary functions. Moreover, in one or more embodiments, the series of acts 1100 includes generating the call graph based on a remaining subset of enumerated binary functions, wherein the call graph is partitioned into bounded code segments.

Additionally, the series of acts 1100 can include determining the threat ranking for the binary function in an isolated container. Further, in one or more embodiments, the series of acts 1100 includes generating the threat object by utilizing the large language model in an additional isolated container.

Moreover, in one or more embodiments, the series of acts 1100 includes an act where the threat parameters correspond to at least one of relevant attack surfaces, relevant vulnerability classes, or threat prioritization criteria of the threat model.

Moreover, in one or more embodiments, the series of acts 1100 includes caching a threat ranking artifact associated with the binary function in a content-addressable store. Additionally, in one or more implementations, the series of acts 1100 can include detecting subsequent analysis related to the binary function associated with the threat ranking artifact. Further, in one or more embodiments, the series of acts 1100 includes hydrating the threat ranking artifact for the subsequent analysis related to the binary function. In one or more cases, the series of acts 1100 can include performing the subsequent analysis related to the binary function associated with the threat ranking artifact.

Furthermore, in one or more cases, the series of acts 1100 includes generating, utilizing the large language model, an exploitation narrative relating to a vulnerability by outlining one or more user input flows to vulnerable code regions associated with the vulnerability of the binary function.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media. Non-transitory computer-readable storage media (devices) includes RAM, ROM, EEPROM, solid state drives (“SSDs”) (e.g., based on RAM), Flash memory, phase-change memory (“PCM”), or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network computers, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of exemplary computing device 1200 (e.g., the server device(s) 202 and/or the client device 210) that may be configured to perform one or more of the processes described above. One will appreciate that server device(s) 202 and/or the client device 210 may comprise one or more computing devices such as computing device 1200. As shown by FIG. 12, computing device 1200 can comprise processor 1202, memory 1204, storage device 1206, I/O interface 1208, and communication interface 1210, which may be communicatively coupled by way of communication infrastructure 1212. While an exemplary computing device 1200 is shown in FIG. 12, the components illustrated in FIG. 12 are not intended to be limiting. Additional or alternative components may be used in other implementations. Furthermore, in certain implementations, computing device 1200 can include fewer components than those shown in FIG. 12. Components of computing device 1200 shown in FIG. 12 will now be described in additional detail.

In particular implementations, processor 1202 includes hardware for executing instructions, such as those making up a computer program. As an example and not by way of limitation, to execute instructions, processor 1202 may retrieve (or fetch) the instructions from an internal register, an internal cache, memory 1204, or storage device 1206 and decode and execute them. In particular implementations, processor 1202 may include one or more internal caches for data, instructions, or addresses. As an example and not by way of limitation, processor 1202 may include one or more instruction caches, one or more data caches, and one or more translation lookaside buffers (TLBs). Instructions in the instruction caches may be copies of instructions in memory 1204 or storage device 1206.

Memory 1204 may be used for storing data, metadata, and programs for execution by the processor(s). Memory 1204 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. Memory 1204 may be internal or distributed memory.

Storage device 1206 includes storage for storing data or instructions. As an example and not by way of limitation, storage device 1206 can comprise a non-transitory storage medium described above. Storage device 1206 may include a hard disk drive (HDD), a floppy disk drive, flash memory, an optical disc, a magneto-optical disc, magnetic tape, or a Universal Serial Bus (USB) drive or a combination of two or more of these. Storage device 1206 may include removable or non-removable (or fixed) media, where appropriate. Storage device 1206 may be internal or external to computing device 1200. In particular implementations, storage device 1206 is non-volatile, solid-state memory. In other implementations, Storage device 1206 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1208 allows a user to provide input to receive output from, and otherwise transfer data to and receive data from computing device 1200. I/O interface 1208 may include a mouse, a keypad or a keyboard, a touch screen, a camera, an optical scanner, network interface, modem, other known I/O devices or a combination of such I/O interfaces. I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1208 is configured to provide graphical data to a display for presentation to a user. The graphical data may be representative of one or more graphical user interfaces and/or any other graphical content as may serve a particular implementation.

Communication interface 1210 can include hardware, software, or both. In any event, communication interface 1210 can provide one or more interfaces for communication (such as, for example, packet-based communication) between computing device 1200 and one or more other computing devices or networks. As an example and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, communication interface 1210 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1210 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1210 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1212 may include hardware, software, or both that couples components of computing device 1200 to each other. As an example and not by way of limitation, communication infrastructure 1212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 13 is a schematic diagram illustrating environment 1300 within which one or more implementations of the binary threat detection system 200 can be implemented. For example, the binary threat detection system 200 may be part of a generative AI system 100 (e.g., the generative AI system 100). Generative AI system 100 may generate, store, manage, receive, and send digital content (such as digital content items). For example, generative AI system 100 may send and receive digital content to and from client devices 1306 by way of network 1304. In particular, generative AI system 100 can store and manage a collection of digital content. Generative AI system 100 can manage the sharing of digital content between computing devices associated with a plurality of users. For instance, generative AI system 100 can facilitate a user sharing a digital content with another user of generative AI system 100. In some cases, the generative AI system 100 can facilitate vulnerability analysis of a binary function.

In particular, generative AI system 100 can manage synchronizing digital content across multiple client devices 1306 associated with one or more users. For example, a user may edit digital content using client device 1306. The generative AI system 100 can cause client device 1306 to send the edited digital content to generative AI system 100. Generative AI system 100 then synchronizes the edited digital content on one or more additional computing devices.

In addition to synchronizing digital content across multiple devices, one or more implementations of generative AI system 100 can provide an efficient storage option for users that have large collections of digital content. For example, generative AI system 100 can store a collection of digital content on generative AI system 100, while the client device 1306 only stores reduced-sized versions of the digital content. A user can navigate and browse the reduced-sized versions (e.g., a thumbnail of a digital image) of the digital content on client device 1306. In particular, one way in which a user can experience digital content is to browse the reduced-sized versions of the digital content on client device 1306.

Another way in which a user can experience digital content is to select a reduced-size version of digital content to request the full- or high-resolution version of digital content from generative AI system 100. In particular, upon a user selecting a reduced-sized version of digital content, client device 1306 sends a request to generative AI system 100 requesting the digital content associated with the reduced-sized version of the digital content. Generative AI system 100 can respond to the request by sending the digital content to client device 1306. Client device 1306, upon receiving the digital content, can then present the digital content to the user. In this way, a user can have access to large collections of digital content while minimizing the amount of resources used on client device 1306.

Client device 1306 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1306 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1304.

Network 1304 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1306 may access generative AI system 100.

As illustrated, the generative AI system 100 communicates with third-party system(s) 1308 by way of the network 1304. For example, the generative AI system 100 generates computer code or scripts for execution by the third-party system(s) 1308 as part of generating an output. In some cases, the generative AI system 100 integrates subcomponents or features of the third-party system(s) 1308 using APIs or other integrations. The third-party system(s) 1308 can include systems housed and operated on servers separate from the generative AI system 100, such as data management systems, calendaring systems, social networking systems, search engine systems, and/or computer other systems.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
retrieving, by a generative artificial intelligence (AI) system, a binary function from a binary repository of a computer application;
determining, utilizing a reverse-engineering platform to perform an initial threat analysis of the binary function, a threat ranking for the binary function;
generating, utilizing a large language model of the generative AI system, a threat model comprising a structured data object defining threat parameters corresponding to the computer application; and
generating, based on the threat ranking and by utilizing a large language model to analyze the binary function together with the threat model, a threat object indicating threat data associated with the binary function.

2. The computer-implemented method of claim 1, further comprising:
enumerating, by the reverse-engineering platform, binary functions of the computer application, wherein the binary functions include the binary function from the binary repository; and
generating a call graph based on enumerating the binary functions.

3. The computer-implemented method of claim 1, further comprising:
generating the threat object by utilizing the large language model in an isolated container, wherein the isolated container prevents the large language model from accessing a control plane associated with the generative AI system.

4. The computer-implemented method of claim 1, wherein the threat parameters corresponding to the computer application comprise at least one of relevant attack surfaces of the binary repository, relevant vulnerability classes of the binary repository, or threat prioritization criteria of the threat model.

5. The computer-implemented method of claim 1, further comprising:
caching a threat ranking artifact associated with the binary function in a content-addressable store;
detecting subsequent analysis related to the binary function associated with the threat ranking artifact; and
rehydrating the threat ranking artifact for the subsequent analysis related to the binary function.

6. The computer-implemented method of claim 1, further comprising incrementally storing one or more outputs associated with analyzing the binary function in a resume-capable format.

7. The computer-implemented method of claim 1, further comprising:
generating, utilizing the large language model, an exploitation narrative outlining one or more steps for exploiting a vulnerability associated with the binary function.

8. A system comprising:
at least one processor; and
a non-transitory computer-readable medium storing instructions which, when executed by the at least one processor, cause the system to:
retrieve, by a generative artificial intelligence (AI) system, a binary function from a binary repository of a computer application;
determine, utilizing a reverse-engineering platform to perform an initial threat analysis of the binary function, a threat ranking for the binary function;
generate, utilizing a large language model of the generative AI system, a threat model comprising a structured data object defining threat parameters corresponding to the computer application;
generate, based on the threat ranking and by utilizing the large language model to analyze the binary function together with the threat model, a threat object indicating threat data associated with the binary function; and
generate an exploitation narrative relating to a vulnerability by outlining one or more user input flows to vulnerable code regions associated with the vulnerability of the binary function.

9. The system of claim 8, further comprising instructions which, when executed by the at least one processor, cause the system to:
enumerate a set of binary functions from the binary repository;
remove trivial binary functions from the set of enumerated binary functions by applying a filter to the set of enumerated binary functions; and
generate a call graph based on a remaining subset of enumerated binary functions.

10. The system of claim 8, further comprising instructions which, when executed by the at least one processor, cause the system to:
coordinate at least one of reading or writing of a shared object stored on a content-addressable store by one or more large language model agents utilizing one or more stigmergic agentic algorithms.

11. The system of claim 8, further comprising instructions which, when executed by the at least one processor, cause the system to:
identify the threat parameters corresponding to at least one of relevant attack surfaces, relevant vulnerability classes, or threat prioritization criteria of the threat model;
receive one or more user inputs modifying at least one of the relevant attack surfaces, the relevant vulnerability classes, or the threat prioritization criteria of the threat model; and
update the threat parameters based on the one or more user inputs.

12. The system of claim 8, further comprising instructions which, when executed by the at least one processor, cause the system to:
cache a threat ranking artifact associated with the binary function in a content-addressable store;
generate a time-limited access token for the threat ranking artifact;
detect subsequent analysis related to the binary function associated with the threat ranking artifact; and
rehydrate, utilizing the time-limited access token, the threat ranking artifact for the subsequent analysis related to the binary function.

13. The system of claim 8, further comprising instructions, which, when executed by the at least one processor, cause the system to:
detect a plurality of candidate user input flows to a plurality of vulnerable code regions;
generate, utilizing the large language model, a plurality of candidate exploitation narratives associated with the plurality of candidate user input flows;
filter, utilizing the large language model, the plurality of candidate exploitation narratives; and
remove duplicate candidate exploitation narratives from the plurality of candidate exploitation narratives.

14. The system of claim 8, further comprising instructions, which, when executed by the at least one processor, cause the system to:
hydrate the binary function associated with the threat object in an isolated container;
detect one or more threats by analyzing an execution of the binary function; and
generate a validated threat object indicating a confirmation of the threat data associated with the binary function.

15. A non-transitory computer-readable medium storing executable instructions which, when executed by at least one processor, cause the at least one processor to:
generate, by a generative artificial intelligence (AI) system, a call graph mapping binary functions in a binary repository of a computer application;
determine, utilizing a reverse-engineering platform to perform an initial threat analysis of a binary function from the call graph, a threat ranking for the binary function utilizing the call graph;
generate, utilizing a large language model of the generative AI system, a threat model comprising a structured data object defining threat parameters corresponding to the computer application; and
generate, based on the threat ranking and by utilizing a large language model to analyze the binary function together with the threat model, a threat object indicating threat data associated with the binary function.

16. The non-transitory computer-readable medium of claim 15, further storing instructions which, when executed by the at least one processor, cause the at least one processor to:
enumerate a set of binary functions from the binary repository;
remove trivial binary functions from the set of enumerated binary functions by applying a filter to the set of enumerated binary functions; and
generate the call graph based on a remaining subset of enumerated binary functions, wherein the call graph is partitioned into bounded code segments.

17. The non-transitory computer-readable medium of claim 15, further storing instructions which, when executed by the at least one processor, cause the at least one processor to:
determine the threat ranking for the binary function in an isolated container; and
generate the threat object by utilizing the large language model in an additional isolated container.

18. The non-transitory computer-readable medium of claim 15, wherein the threat parameters correspond to at least one of relevant attack surfaces, relevant vulnerability classes, or threat prioritization criteria of the threat model.

19. The non-transitory computer-readable medium of claim 15, further storing instructions which, when executed by the at least one processor, cause the at least one processor to:
cache a threat ranking artifact associated with the binary function in a content-addressable store;
detect subsequent analysis related to the binary function associated with the threat ranking artifact;
hydrate the threat ranking artifact for the subsequent analysis related to the binary function; and
perform the subsequent analysis related to the binary function associated with the threat ranking artifact.

20. The non-transitory computer-readable medium of claim 15, further storing instructions which, when executed by the at least one processor, cause the at least one processor to:
generate, utilizing the large language model, an exploitation narrative relating to a vulnerability by outlining one or more user input flows to vulnerable code regions associated with the vulnerability of the binary function.
